(19) United States
(12) Patent Application Publication
(10) Pub. No.: US 2024/0130309 A1
(43) Pub. Date: Apr. 25, 2024

(54) GROW TRAY

(71) Applicant: Jones Food Company Limited, Scunthorpe (GB)

(72) Inventors: Stephen MILLWARD, Hatfield, Hertfordshire (GB); Andrew INGRAM-TEDD, Hatfield, Hertfordshire (GB); James LLOYD-JONES, Scunthorpe (GB); Glyn STEPHENS, Scunthorpe (GB); Christoph GRUNDMANN, Scunthorpe (GB); Pawel KAROLINCZAK, Scunthorpe (GB)

(73) Assignee: Jones Food Company Limited, Scunthorpe (GB)

(21) Appl. No.: 18/546,444

(22) PCT Filed: Feb. 17, 2022
(86) PCT No.: PCT/EP2022/054013

§ 371 Date: Aug. 14, 2023

(30) Foreign Application Priority Data
Feb. 17, 2021 (GB) 2102209.0

(51) Int. Cl. A01G 31/06

(52) U.S. Cl. CPC A01G 31/06

(57) ABSTRACT

A grow tray including a perimeter wall and a base. The base includes an irrigation opening extending through the base for allowing fluid to enter and leave the grow tray. The base is couplable to a conduit to allow fluid communication between the conduit and the base via the irrigation opening.

### TECHNICAL FIELD

The invention relates to a grow tray for containing growing crops, particularly a grow tray for use in a farming system, such as a hydroponic farming system.

### BACKGROUND

Historically, systems and methods for growing crops have required large areas of land and have needed to be in located in places with an appropriate climate for the crops to grow effectively.

Indoor farming under artificial lights is gaining popularity for a large number of crops. There are many benefits associated with indoor farming, such as reduced needs for water, fertilisers and pesticides, as well as increased control of taste, texture and other features of the crop.

More recently, advanced farming techniques such as hydroponics, aeroponics and other such cultivation systems have led to the ability to grow high quality crops indoors with very high utilisation of lighting, water and fertiliser.

Commercially viable indoor farming solutions require maximisation of efficient use of space and other resources such as lighting, fluids, and labour.

Presently, mainly short plants, such as herbs and leafy greens are grown indoors under artificial light.

An example of an indoor farm is disclosed in WO202030825A1. Seeds are pre-treated and germinated in a ‘high care’ portion to reduce contamination during germination. Seedlings are then moved through a growing room in support vehicles containing grow trays which move along a frame as the crop grows and until the crop is ready for harvesting. The system includes lights above each growing station, and a recirculating irrigation system for providing nutrients to the growing crops. The irrigation system uses mains water blended with nutrients, which is pumped to the growing crop. Water which drains from the racks is reintroduced to the water blend to minimise waste water.

WO'825 describes an apparatus for use in a hydroponic growing system. The apparatus is located within a high care facility within the hydroponic growing system. The apparatus comprises a frame of vertical members 103 and horizontal members 104 supporting horizontal tracks or guideways on which a set of growing vehicles are mounted. The growing vehicles each contain a number of growing trays in which plants or crops are accommodated whilst they grow.

In WO'825, the size of the facility is limited by the size of the building and frame within. The temperature, humidity and wind speed are controlled within the high care facility. The environment is substantially the same for each growing tray. Accordingly, typically the same crop or type of crop is grown in each track. In the arrangement described in WO'825 it is only possible to access trays sequentially from each track or guideway. Mechanical failure of a track may render a large portion of the facility inaccessible until it is repaired.

The present invention aims to further develop indoor growing, vertical or controlled environment farming systems and methods. In particular, the present invention aims to further the art in hydroponic growing systems that allows for more efficient use of water, reduced plumbing, and more precise control of the water being delivered to each crop.

It will be appreciated that the present invention also aims to maximise the yield, and improve efficiency in terms of use of assets, resources and services required by the crop. These efficiencies may comprise, for example: reduced needs for water; reduced needs for fertilisers and pesticides; increase in the control of taste; increase in the control of texture and other features of the crop; efficiencies in the use of artificial lighting; efficiencies in maintenance of the facilities; improved utilisation of space; improved safety; an increase in automation and corresponding decrease in labour. Overall, the present invention aims to address issues enabling more growth in a smaller space with less electricity consumption, less capital expenditure, less maintenance and less labour cost.

Furthermore, the benefits from controlled environment or vertical farming systems are likely to become more pronounced as improved infrastructure components such as more efficient and cheaper lights, and cheaper electricity become available.

### SUMMARY OF INVENTION

The invention is defined in the accompanying claims.

Farming System

A farming system is provided. The farming system comprises: a support structure comprising a tray-receiving location for receiving a grow tray, and an irrigation system for supplying fluid to and draining fluid from the tray-receiving location. The irrigation system comprises a tray conduit couplable to the bottom of a grow tray when located in the tray-receiving location to allow fluid communication between the tray conduit and said grow tray via an irrigation opening extending through the base of said grow tray. The irrigation system is arranged to both supply fluid to and drain fluid from said grow tray via the tray conduit.

The farming system may be an indoor farming system. The farming system may be a hydroponic farming system.

The fluid used in the farming system may be a liquid or liquid solution, e.g. water with dissolved nutrients or other substances for crop growth. Hereafter, the term “water” includes water with dissolved nutrients or other substances.

By filling the grow tray from the bottom-up, the volume of water delivered to the grow tray and the period of time that the grow tray contains fluid can be more precisely controlled compared to top-down irrigation systems, for example. As a result, water can be used more efficiently and the growth of the crops contained in the grow tray can be more optimally controlled. Furthermore, the amount of plumbing in the irrigation system may be minimised as f can be both delivered and drained using the same conduit.

The irrigation system may further comprise: a branch conduit, a substantially vertically extending supply conduit and a substantially vertically extending drainage conduit. The branch conduit may be fluidly coupled to the tray conduit, the supply conduit and the drainage conduit. The supply conduit may be arranged to supply fluid to the tray conduit via the branch conduit. The drainage conduit may be arranged to drain fluid from the tray conduit via the branch conduit. The branch conduit may extend transversely between the supply conduit and the drainage conduit. The branch conduit may extend substantially horizontally.

The drainage conduit may be selectively closable to prevent fluid from draining out of the drainage conduit. This allows water to fill within the irrigation system when the drainage conduit is closed.

The irrigation system may further comprise a drainage valve selectively movable between an open position for allowing fluid communication and a closed position for blocking fluid communication. The drainage valve may be arranged between the branch conduit and the drainage conduit. By controlling the drainage valve, the drainage from the grow tray can be controlled. If a plurality of branch conduits are provided, then a drainage valve may be arranged between each branch conduit and the drainage conduit. Each drainage valve may be individually controllable. This allows the grow trays served by the same branch conduit to be treated as a batch, and the grow trays served by different branch conduits to be treated as separate batches.

The irrigation system may further comprise a supply valve selectively moveable between an open position for allowing fluid communication and a closed position for blocking fluid communication. The supply valve may be arranged between the branch conduit and the supply conduit. By controlling the supply valve, the supply of water to the grow tray can be controlled. If a plurality of branch conduits are provided, then a supply valve may be arranged between each branch conduit and the supply conduit. The supply valves may be located on the branch conduits, on the supply conduit, or at the intersections between the branch conduits and the supply conduit. Each supply valve may be individually controllable. This allows the grow trays served by the same branch conduit to be treated as a batch, and the grow trays served by different branch conduits to be treated as separate batches.

The branch conduit may define a drainage overflow level at or near the drainage conduit. Above the drainage overflow level, fluid may flow from the branch channel to the drainage conduit. Below the drainage overflow level, fluid may not flow from the branch conduit to the drainage conduit. The drainage overflow level may be higher than the branch conduit and lower than the bottom of a grow tray when located in the tray-receiving location to allow fluid to be retained in the branch conduit at the drainage overflow level after draining from said grow tray. In this way, the time between water being supplied to the supply conduit and water entering the grow tray can be reduced for consecutive supply and drain operations.

The branch conduit may define a supply overflow level at or near the supply conduit. Above the supply overflow level, fluid may flow from the branch channel to the supply conduit. Below the supply overflow level, fluid may not flow from the branch conduit to the supply conduit. The supply overflow level may be higher than tray conduits. The supply overflow level may be higher than at least a portion of the grow tray when located in the tray receiving location. The supply overflow level may be higher than a predetermined level of the grow tray when located in the tray receiving location.

The supply conduit and the drainage conduit may share a common service conduit. The branch conduit may be fluidly coupled to the tray conduit and the service conduit.

The irrigation system may further comprise a selector valve assembly coupled between the service conduit and the branch conduit. The selector valve assembly may comprise: a supply channel fluidly coupled to the service conduit; a drain channel fluidly coupled to the service conduit; and a flow-selector channel fluidly coupled between the supply channel and the drain channel and further fluidly coupled to the branch conduit. The flow-selector channel may comprise a selector member movable within the flow-selector channel between a supply position in which fluid communication between the drain channel and the flow-selector channel is blocked and fluid communication between the supply channel and the flow-selector channel is open to allow fluid to flow from the service conduit to the branch channel via the supply channel and the flow-selector channel, and a drain position in which fluid communication between the supply channel and the flow-selector channel is blocked and fluid communication between the drain channel and the flow-selector channel is open to allow fluid to flow from the branch conduit to the service conduit via the flow-selector channel and the drain channel. In this way, the irrigation system may be more compact with fewer components.

The selector member may be freely moveable within the flow-selector channel such that the selector member can be urged to the supply position when fluid is flowing into the supply channel from the service conduit and urged to the drain position when fluid is flowing into the flow-selector channel from the branch conduit. This allows the supply and drainage of water into and out of the grow tray to be passively controlled, rather than actively controlled.

The supply channel may comprise a supply flow regulator configured to regulate flow through the supply channel to a predetermined supply flow rate. The drain channel may comprise a drainage flow regulator configured to regulate flow through the drain channel to a predetermined drainage flow rate. The predetermined supply flow rate may be different to the predetermined drainage flow rate, e.g. the predetermined supply flow rate may be higher than the predetermined drainage flow rate, or vice versa.

The drain channel may further comprise a non-return valve configured to allow fluid to flow in a direction towards the service conduit and prevent fluid from flowing in an opposite direction.

The supply channel and the drain channel may be orientated substantially horizontally and may be vertically spaced from each other. The flow-selector channel may be orientated substantially vertically. The selector member may be vertically movable between the supply position and the drain position.

The supply channel may be arranged below the drain channel. The branch conduit may be fluidly coupled to the top of the flow-selector channel. The supply position of the selector member may be vertically above the drain position.

The supply channel may be arranged at or near a first end of the flow-selector channel and the drain channel may be arranged at or near a second end of the flow-selector channel. The drain position of the selector member may be arranged at the first end of the flow selector channel and the supply position of the selector member may be arranged at the second end of the flow selector channel.

The tray conduit may comprise a toroidal protrusion or a toroidal recess for coupling to a complementary toroidal recess or toroidal protrusion respectively encircling the irrigation opening of a grow tray when located in the tray-receiving location. The toroidal protrusion or toroidal recess of the tray conduit may encircle an opening at an end of the tray conduit. The toroidal protrusion or toroidal recess of the tray conduit may comprise an elastomeric member (e.g. an O-ring). By providing a toroidal coupling interface, the grow tray and the tray conduit may couple without leakage even if the grow tray is slightly horizontally offset from the tray conduit or inclined to the horizontal when located in the tray-receiving location, and at any rotational orientation.

The tray-receiving location may comprise a locating protrusion or locating recess for cooperating with a complementary locating recess or locating protrusion respectively on a grow tray when located in the tray-receiving location to prevent movement of the grow tray in a horizontal direction relative to the support structure.

The tray-receiving location may comprise: a support surface for supporting a grow tray located in the tray-receiving location, and an inclined guide surface for guiding the grow tray towards the support surface and locating the grow tray on the support surface. The support surface may be arranged at the bottom of the incline of the inclined guide surface. The support surface may be arranged at least partially around the perimeter of the tray-receiving location.

The farming system may further comprise a grow tray. The grow tray may comprise a base and an irrigation opening extending through the base. The bottom of the base may be couplable to the tray conduit to allow fluid communication between the tray conduit and the grow tray when the grow tray is located in the tray-receiving location.

The bottom of the grow tray may comprise a toroidal recess or toroidal protrusion encircling the irrigation opening of the grow tray for coupling to a toroidal protrusion or toroidal recess respectively on the tray conduit when the grow tray is located in the tray-receiving location. The toroidal recess or toroidal protrusion of the grow tray may comprise an elastomeric member (e.g. an O-ring).

The grow tray may comprise a locating recess or locating protrusion for cooperating with a locating protrusion or locating recess respectively at the tray-receiving location when the grow tray is located in the tray-receiving location. The locating recess or protrusion of the grow tray may, for example, be arranged on the bottom of the grow tray or a perimeter wall of the grow tray.

The support structure may define a plurality of vertically-spaced levels, each level comprising one or more tray-receiving locations. The irrigation system may comprise a plurality of branch conduits, each branch conduit being fluidly coupled to one or more of the tray conduits at a particular level of the support structure.

Method

A method of using the above farming system above is provided, where the farming system further comprises a grow tray located in the tray-receiving location and coupled to the tray conduit. The method comprises:
(i) supplying fluid to the irrigation system to fill the grow tray with fluid via the tray conduit;
(ii) stopping the supply of fluid once the fluid has reached a predetermined fluid level within the grow tray; and
(iii) allowing the fluid to drain from the grow tray via the tray conduit.

This process allows for more precise control over the volume of fluid the grow tray receives and the period of time the grow tray is filled with fluid.

The fluid in the grow tray may be held at the predetermined fluid level for a predetermined period of time before allowing the fluid to drain from the grow tray.

Drainage from the irrigation system may be blocked while fluid is supplied to the irrigation system and allowed to allow the fluid to drain from the grow tray. Where the irrigation system comprises a drainage valve, drainage from the irrigation system may be blocked and allowed by closing and opening the drainage valve respectively.

In the case where the farming system comprises a supply valve and a drain valve, step (i) of the method may further comprise closing the supply valve and the drain valve, supplying fluid to the supply conduit, then opening the supply valve to fill the grow tray with fluid via the tray conduit. Step (ii) may further comprise closing the supply valve and stopping the supply of fluid to the supply conduit. Step (iii) may further comprise opening the drain valve to allow fluid to drain from the grow tray via the tray conduit.

In the case where the support structure defines a plurality of vertically-spaced levels and the irrigation system comprises a plurality of branch conduits, the method may comprise supplying fluid to only a subset of the branch conduits (e.g. by opening a subset of the supply valves) so that only the grow trays on the levels corresponding to the subset of branch conduits is filled with fluid. The method may comprise draining fluid from only a subset of the plurality of branch conduits (e.g. by opening a subset of the drainage valves) so that only the grow trays on the levels corresponding to the subset of branch conduits are drained of fluid. In this way, the grow trays on different levels of the support structure may be treated as separate batches.

Selector Valve Assembly

A selector valve is provided, comprising: a supply channel; a drain channel; and a flow-selector channel fluidly coupled between the supply channel and the drain channel.

The supply channel may be fluidly couplable to a service conduit; the drain channel may be fluidly couplable to the service conduit, and the flow-selector channel may be fluidly couplable to a branch conduit.

The flow-selector channel may comprise a selector member movable within the flow-selector channel between a supply position in which fluid communication between the drain channel and the flow-selector channel is blocked and fluid communication between the supply channel and the flow-selector channel is open, and a drain position in which fluid communication between the supply channel and the flow-selector channel is blocked and fluid communication between the drain channel and the flow-selector channel is open.

The flow-selector channel may be urged to the supply position when fluid is flowing from the supply channel to the flow-selector channel. The flow selector channel may be urged to the drain position when fluid is flowing from the flow-selector channel to the drain channel.

The supply channel may comprise a supply flow regulator configured to regulator flow through the supply channel to a predetermined supply flow rate. The drain channel may comprise a drainage flow regulator configured to regulate flow through the drain channel to a predetermined drainage flow rate. The predetermined supply flow rate may be different to the predetermined drainage flow rate, e.g. the predetermined supply flow rate may be higher than the predetermined drainage flow rate, or vice versa.

The drain channel may further comprise a non-return valve configured to allow fluid to flow in a direction away from the flow-selector channel and prevent fluid from flowing in an opposite direction.

The supply channel and the drain channel may be orientated substantially parallel to each other. The flow-selector channel may be orientated substantially perpendicular to the supply channel and the drain channel.

The supply channel may be arranged at or near a first end of the flow-selector channel and the drain channel may be arranged at or near a second end of the flow-selector channel. The drain position of the selector member may be arranged at the first end of the flow selector channel and the supply position of the selector member may be arranged at the second end of the flow selector channel.

Grow Tray

A grow tray is provided. The grow tray may be for use in the above farming system. The grow tray comprises: a perimeter wall; and a base comprising an irrigation opening extending through the base for allowing fluid to enter and leave the grow tray. The base may be couplable to a conduit to allow fluid communication between the conduit and the base via the irrigation opening.

The irrigation opening may be disposed at the centre of the base.

The base may further comprise:
one or more primary channels extending between the irrigation opening and the perimeter wall, the one or main channels dividing the base into a plurality of contiguous sections;
wherein each section comprises a plurality of secondary channels, each secondary channel being connected to at least one of the primary channels to allow fluid communication between the irrigation opening and the secondary channels via the one or more primary channels.

The base may comprise a plurality of primary channels extending radially from the irrigation opening towards the perimeter wall. The plurality of secondary channels may extend circumferentially about the irrigation opening between adjacent primary channels.

The plurality of secondary channels may be arranged to form a plurality of concentric rings centred on the irrigation opening.

The base may further comprise a plurality of tertiary channels extending radially between adjacent secondary channels to allow fluid communication between the secondary channels via the tertiary channels.

The base may comprise an inner portion comprising the primary and secondary (and tertiary) channels. The base may further comprise a perimeter portion surrounding the inner portion. The perimeter portion may comprise a plurality of secondary perimeter channels extending perpendicularly from the perimeter wall to the inner portion to allow fluid communication between the inner portion and the perimeter wall.

The primary and secondary channels may have different depths. The primary channels may be deeper than the secondary channels. The primary channels may be approximately twice as deep as the secondary channels.

The primary and secondary (and tertiary) channels may be defined by grooves in the base.

The base may comprise a substantially horizontal top surface for supporting a sheet of growing substrate in a substantially horizontal orientation.

The base may further comprise a plurality of radially extending fins located in the irrigation opening that partially define the substantially horizontal top surface.

The base may further comprise one or more main channels extending between the irrigation opening and the perimeter wall, the one or main channels dividing the base into a plurality of contiguous sections. Each section may comprise a plurality of branch channels, each branch channel being connected to one of the main channels to allow fluid communication between the irrigation opening and the branch channels via the one or more main channels. This arrangement allows for uniform distribution of water across the base and helps to avoid dead zones where it is difficult for water to reach or drain from.

Each branch channel may extend to the perimeter wall. Alternatively, each branch channel may end before the perimeter wall to form a perimeter channel adjacent to the perimeter wall.

Each branch channel within each section may extend substantially in the same direction.

Each branch channel may have substantially the same width as each other.

Each section may incline downwards towards the irrigation opening to encourage drainage. The branch channels in each section may extend substantially in the same direction as the incline of the section.

The one or more main channels and/or the branch channels may extend substantially linearly.

The sections may have substantially the same area as each other. The sections may be symmetrically disposed about the irrigation opening. The sections may be substantially triangular. The number of sections formed by the main channels may be one greater than the number of main channels.

The base may be substantially flat (i.e. all sections may lie in the same plane). Alternatively, each section may incline downwards towards the irrigation opening. The slope of each section may be approximately 1:50 or less. The slope of each section may be at least approximately 1:100. The slope of each section may be approximately between 1:100 and 1:50. The slope of each section may be approximately 1:100, 1:90, 1:80, 1:70, 1:60 or 1:50.

The base may further comprise a plurality of upstanding ribs. Each branch channel may be defined between two adjacent ribs.

Each rib may have a wavy shape (e.g. a sinusoidal shape). This provides strength to the ribs and reduces the risk of the ribs breaking off the base. As a result, the ribs may be thinner.

The top of the plurality of ribs may provide a substantially horizontal surface for supporting a sheet of growing substrate in a substantially horizontal orientation. This allows the growing substrate to be raised off the base, which facilitates drainage, and allows the roots of the crops to be suspended in air, which may be beneficial to crop growth.

Alternatively, the one or more main channels and the branch channels may be defined by grooves in the base.

The bottom of the base may comprise a toroidal protrusion or toroidal recess encircling the irrigation opening for cooperating with a complementary toroidal recess or toroidal protrusion respectively on a conduit to be coupled to the bottom of the base. By providing a toroidal coupling interface, the grow tray and the conduit may couple without leakage even if the grow tray is slightly horizontally offset from the conduit or inclined to the horizontal, and at any rotational orientation.

The bottom of the base may further comprise a groove encircling the toroidal protrusion or toroidal recess for receiving an end of the conduit. This may help to stabilise the coupling between the grow tray and the conduit.

The base may further comprise a first pair of parallel perimeter edges. The grow tray may further comprise a first pair of diametrically opposed locating features extending parallel to the first pair of parallel perimeter edges for cooperating with a complementary pair of locating features on a support structure. The midpoints of the locating features of the first pair of locating features may be aligned along a first axis running through the centre of the irrigation opening and perpendicularly through the first pair of parallel perimeter edges.

This arrangement may be advantageous if the grow tray shrinks during or after manufacture (e.g. if the grow tray is formed using a plastic moulding process). By aligning the locating features and the irrigation hole as above, the relative positions of the midpoints of the locating features and the centre of the irrigation hole may stay the same, regardless of the amount of shrinkage. Therefore, the grow tray is more likely to align with a tray conduit in the above farming system when located into a tray-receiving location with corresponding locating features.

The base may further comprise a second pair of parallel perimeter edges. The grow tray may further comprise a second pair of locating features extending parallel to the second pair of parallel perimeter edges for cooperating with a complementary pair of locating features on a support structure. The midpoints of the locating features of the second pair of locating features may be aligned along a second axis running through the centre of the irrigation opening and perpendicularly through the second pair of parallel perimeter edges.

The locating features may be arranged on the bottom of the base, e.g. at or near the perimeter edges of the base. The locating features may be arranged on the perimeter wall.

The first and/or second pair of locating features may be protrusions or recesses. The protrusions or recesses may have inclined side surfaces, e.g. they may be trapezoidal shaped.

This allows the grow tray to self-locate onto the support structure.

The grow tray may further comprise:
one or more stacking protrusions disposed on one of: (i) the bottom side of the base; and (ii) the top of the perimeter wall; and
one or more complementary stacking recesses disposed on the other of: (i) the bottom side of the base; and (ii) the top of the perimeter wall.

A maximum height of the one or more stacking protrusions may be larger than a maximum height of the one or more stacking recesses to form a vertical gap between adjacent grow trays when vertically stacked. In this way, air may flow between the grow trays in the stack, which may be beneficial for seed germination before the grow trays are moved onto the support structure.

The protrusions and recesses may have inclined side surfaces, e.g. they may have a trapezoidal shape. This allows the grow trays to self-locate on top of each other when stacked.

The base may be rectangular (including a square shape).

Thus, a farming system and method, and tray are provided for improving indoor farming systems.

### BRIEF DESCRIPTION OF THE DRAWINGS

Embodiments of the present invention will now be described, by way of example only, with reference to the accompanying drawings, in which like reference numerals are used for like features, and in which:

FIG. 1 is a perspective view of a farming system showing a support structure, an irrigation system and grow trays.

FIG. 2 is a front view of the farming system of FIG. 1.

FIG. 3 is a perspective view of the farming system of FIG. 1 with the grow trays removed.

FIG. 4 is a schematic illustration of a variation of the irrigation system.

FIG. 5 is a perspective view of an alternative farming system showing a support structure, an irrigation system and grow trays.

FIG. 6 is a front view of the farming system of FIG. 5.

FIG. 7 is a perspective view of a selector valve assembly used in the farming system of FIG. 5.

FIG. 8 is a schematic sectional view of the selector valve assembly shown in FIG. 7.

FIG. 9 is a perspective view of a first grow tray.

FIG. 10 is a partial perspective view of the bottom of the first grow tray of FIG. 9.

FIG. 11 is a top view of the first grow tray of FIG. 9.

FIG. 12 is a partial side view of the first grow tray of FIG. 9.

FIG. 13 is a perspective view of a second grow tray.

FIG. 14 is a top view of the second grow tray.

FIG. 15 is a close-up view of the irrigation opening of the second grow tray.

FIG. 16 is a perspective view of the underside of the second grow tray.

FIG. 17 is a perspective view of a tray conduit for coupling to the first or second grow tray.

FIG. 18 is a perspective view of the second grow tray on a support structure.

### DETAILED DESCRIPTION

The present invention relates to a farming system, such as a hydroponic farming system, comprising, in combination or in isolation, grow trays for containing growing crops, a support structure for supporting the grow trays and an irrigation system for supplying and draining fluid to the grow trays on the support structure. Each of these aspects are described in more detail in the sections below.

The fluid used in the farming system may be a liquid or liquid solution, e.g. water with dissolved nutrients or other substances for crop growth. Hereafter, the term “water” includes water with dissolved nutrients or other substances.

Support Structure

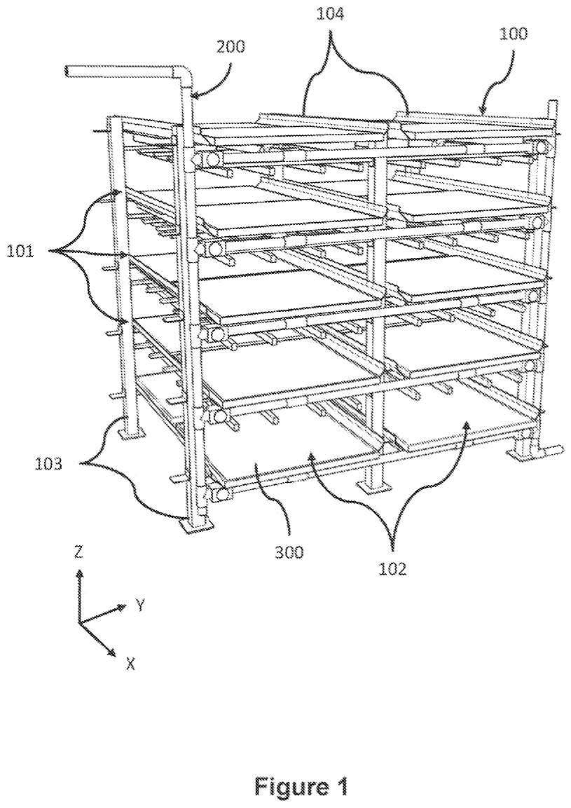

For convenience, a set of axes labelled X, Y and Z, is illustrated in FIG. 1. In the following description, the term “vertical” refers to a direction parallel to the Z-axis and the term “horizontal” refers to a direction parallel to the X-Y plane.

FIG. 1 shows a farming system comprising a support structure 100 for receiving and supporting grow trays 300 in vertically-spaced levels 101 defined by the support structure 100. Each level 101 comprises at least one tray-receiving location 102. Each tray-receiving location 102 is arranged to receive one grow tray 300. The support structure 100 of FIG. 1 has five levels 101, with each level 101 comprising four tray-receiving locations 102. However, the support structure 100 may comprise more or fewer levels 101 (i.e. one or more levels) and each level 101 may comprise more or fewer tray-receiving locations 102 (i.e. one or more tray-receiving locations) depending on the crop yield required and the space available for the support structure 100.

The grow trays 300 are individually coupled to the irrigation system 200 and therefore each tray receiving location comprises features that help to locate the grow trays 300 into the correct position relative to the irrigation system 200.

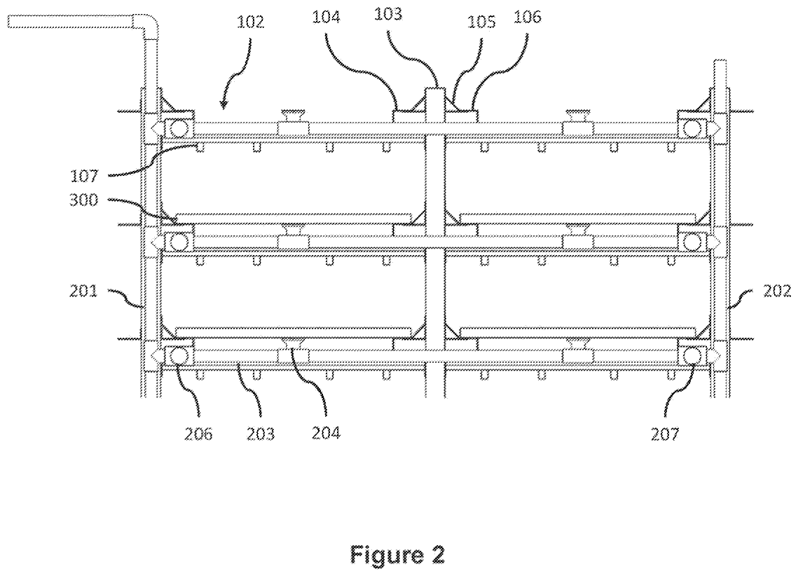

FIG. 2 shows a front view of the support structure 100. Each tray-receiving location 102 comprises a support surface 106 which supports the bottom of a grow tray 300 when placed in a tray-receiving location 102. Each tray-receiving location 102 further comprises an inclined guide surface 105 for guiding a grow tray 300 towards the support surface 106 and locating the grow tray 300 on the support surface 106. In particular, the support surface 106 is arranged at the bottom of the incline of the guide surface 105 so that if a grow tray 300 is offset from the support surface 106 when being placed into a tray-receiving location 102, the grow tray 300 may engage and slide down the inclined guide surface 105, causing the grow tray 300 to move towards the support surface 106. The guide surfaces 105 thus help to guide and locate the grow trays 300 into a particular position on the support structure 100 so that the grow trays 300 can couple to the irrigation system 200.

The tray-receiving locations 102 are defined, at least in part, by horizontal members 104 which comprise the support surfaces 106 and guide surfaces 105. The horizontal members 104 are supported by vertical members 103. The support structure 100 is modular in the sense that it can be expanded to provide more tray-receiving locations 102 by increasing the number of vertical members 103 and horizontal members 104.

The support structure 100 further comprises artificial light sources 107 mounted above each tray-receiving location 102 to provide light to each grow tray 300 from above. The light sources 107 may be strip lights (e.g. LED strip lights).

The support structure 100 may comprise additional locating features that further help to correctly position the grow trays 300 with respect to the irrigation system 200 and/or prevent the grow trays 300 from moving in a horizontal direction once they have been placed in the tray-receiving locations 102. For example, each tray-receiving location 102 may comprise a locating feature (not shown) that cooperates with a complementary locating feature on a grow tray 300. These locating features may, for example, take the form of a protrusion on the support structure 100 that is received in a recess in the bottom of the grow tray 300, or vice versa.

Each tray-receiving location 102 may be associated with a unique identifier, e.g. a barcode or RFID tag, mounted at or adjacent to each tray-receiving location 102, that may be used to uniquely identify each tray-receiving location 102 on the support structure 100. These unique identifiers, in combination with unique identifiers for each grow tray 300, may be used to record and track the location of each grow tray 300 on the support structure 100.

Irrigation System

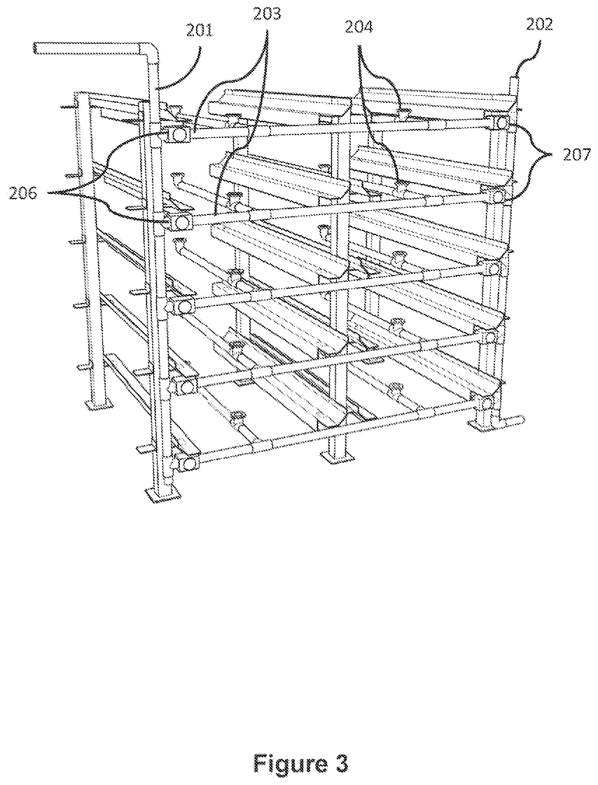

FIGS. 1-3 show the irrigation system 200 of the farming system. FIG. 3 shows the system of FIG. 1 with the grow trays 300 and artificial light sources 107 removed so that the irrigation system 200 can be seen in more detail.

The irrigation system 200 is arranged to supply fluid to, and drain fluid from, the grow trays 300 located in the tray-receiving locations 102 of the support structure 100. The fluid will typically be a liquid or liquid solution, e.g. water with dissolved nutrients or other substances for crop growth.

Each grow tray 300 comprises an irrigation opening 303 extending through the base 301 of the grow tray 300 through which fluid from the irrigation system 200 may enter and leave the grow tray 300.

The irrigation system 200 comprises tray conduits 204 for coupling to the grow trays 300. For each tray-receiving location 102, the irrigation system 200 comprises a tray conduit 204 that is couplable to the bottom of a grow tray 300 when located in the tray-receiving location 102 to allow fluid communication between the tray conduit 204 and the grow tray 300 via the irrigation opening 303. In particular, the tray conduit 204 comprises an opening arranged vertically below the grow tray 300 that aligns with the grow tray irrigation opening 303 when the tray conduit 204 is coupled to the grow tray 300.

The irrigation system 200 is arranged to both supply fluid to and drain fluid from the grow tray 300 via the tray conduit 204. In other words, the irrigation system 200 does not require separate conduits for handling fluid supply and fluid drainage for each grow tray 300.

The irrigation system 200 further comprises a plurality of branch conduits 203, a supply conduit 201, and a drainage conduit 202.

Each branch conduit 203 is fluidly coupled to one or more tray conduits 204 at a particular level 101 of the support structure 100. Each branch conduit 203 is further fluidly coupled between the supply conduit 201 and the drainage conduit 202. The supply conduit 201 and the drainage conduit 202 extend substantially vertically between the levels 101 of the support structure 100 and each branch conduit 203 extends transversely between the supply conduit 201 and the drainage conduit 202. Thus, the irrigation system 200 comprises vertically-spaced branch conduits 203 corresponding to the vertically-spaced levels 101 of the support structure 100. In use, fluid is directed from the supply conduit 201 to the tray conduits 204 via the branch conduits 203, and fluid is drained from the tray conduits 204 to the drainage conduit 202 via the branch conduits 203.

The irrigation system 200 is arranged to receive a supply of fluid into the top of the supply conduit 201. The fluid may be pumped directly from a mains supply, or may be pumped from an intermediate tank to allow the fluid to be treated before being pumped to the supply conduit 201. For example, the fluid may be sterilised, dosed with nutrients and/or the pH may be modified.

The drainage conduit 202 is arranged to receive fluid drained under gravity from the grow trays 300. Drained fluid may be recycled into the irrigation system 200 or used elsewhere in the farming facility.

The supply conduit 201 and drainage conduit 202 may be mounted to a vertical member 103 of the support structure 100 for support, or may be supported independently of the support structure 100.

The irrigation system 200 further comprises a plurality of drainage valves 207. Each drainage valve 207 is coupled between the drainage conduit 202 and a branch conduit 203 and is selectively movable between an open position for allowing fluid communication between the drainage conduit 202 and the branch conduit 203, and a closed position for blocking fluid communication between the drainage conduit 202 and the branch conduit 203. Thus, when the drainage valves 207 are closed, fluid entering the irrigation system 200 from the supply conduit 201 may exit the irrigation system 200 via the tray conduits 204.

The drainage valves 207 may be electrically controlled valves, e.g. solenoid valves. The drainage valves 207 may be individually controllable. In this way, fluid from each branch conduit 203 can be individually drained so that the grow trays 300 on different levels 101 may be considered as separate batches. If individual control at each branch conduit 203 is not required, the drainage valves 207 may be controlled as a group, or a drainage valve 207 could be provided at the bottom of the drainage conduit 202 (below the bottom-most level 101 of the support structure 100) instead.

In general, the drainage conduit 202 is selectively closable so that when the drainage conduit 202 is closed, fluid is prevented from draining out of the drainage conduit 202.

The irrigation system 200 further comprises a plurality of supply valves 206. Each supply valve 206 is coupled between the supply conduit 201 and a branch conduit 203 and is selectively movable between an open position for allowing fluid communication between the supply conduit 201 and the branch conduit 203, and a closed position for blocking fluid communication between the supply conduit 201 and the branch conduit 203.

The supply valves 206 may, for example, be located on each branch conduit 203; on the supply conduit 201 (e.g. above or below the entrance to each branch conduit 203), or at the intersections between the supply conduit 201 and the branch conduits 203.

The supply valves 206 may be electrically controlled valves, e.g. solenoid valves. The supply valves 206 may be individually controllable. In this way, the fluid to each branch conduit 203 can be individually supplied so that the grow trays 300 on different levels 101 may be considered as separate batches. However, if the fluid supply to each branch conduit 203 does not need to be individually controlled, then the supply valves 206 may be controlled as a group. Alternatively, the supply valves 206 may be removed entirely, with the control of fluid into the supply conduit 201 serving as the control of fluid into the branch conduits 203.

A method of using the irrigation system 200 to supply water to and drain water from grow trays 300 placed in the tray-receiving locations 102 of the support structure 100 will now be described.

Before first use of the system, the supply conduit 201, the drainage conduit 202, the branch conduits 203 and the tray conduits 204 may be empty of water.

Grow trays 300 containing, e.g. a sheet of growing medium and germinated seeds or growing crops, are placed into the tray-receiving locations 102 on the support structure 100. Each grow tray 300 comprises an irrigation opening 303 extending through the base 301 of the grow tray 300. Once placed in a tray-receiving location 102, the bottom of the base 301 of a grow tray 300 couples to a tray conduit 204 so that the irrigation opening 303 of the grow tray 300 and the tray conduit 204 are in fluid communication.

The supply valves 206 and drainage valves 207 are moved to the closed position and water is supplied into the supply conduit 201. Because the supply valves 206 are closed, the supply conduit 201 will begin to fill with water. Once the supply conduit 201 is full, the supply valves 206 are opened to allow water to flow from the supply conduit 201 into the branch conduits 203.

At this point, water is still being supplied into the supply conduit 201. Because the drainage valves 207 are closed, water cannot enter the drainage conduit 202, and therefore the only route for the water to take is out through the tray conduits 204 and into each grow tray 300 via the irrigation opening 303 in the base 301 of each grow tray 300. Each grow tray 300 therefore begins to fill with water from the bottom up.

Water is continuously supplied to the supply conduit 201 until the water in each grow tray 300 has risen to a predetermined level (i.e. height) above the base 301 of the grow trays 300. Once the water has reached the predetermined level, the supply valves 206 are closed and the supply of water into the supply conduit 201 is stopped. The point at which the supply of water into to the supply conduit 201 can be stopped (i.e. the point at which the water in each grow tray 300 has reached the predetermined level) can be determined by knowing in advance the volume of water required to fill the irrigation system 200 and the grow trays 300 to the predetermined level. Once that volume of water has been supplied to the supply conduit 201 (e.g. by supplying the water at a particular flow rate for a particular period of time), then the supply of water to the supply conduit 201 can be stopped.

At this point, the water in the irrigation system 200 is at rest and the water in the grow trays 300 remains held within the grow trays 300. The water is held in this state for a predetermined period of time (e.g. on the order of minutes or hours) to allow the roots of the crops in the grow trays 300 to absorb the water they require for optimum growth.

To subsequently drain the water from the grow trays 300, the drainage valves 207 are opened, which allows the water in each grow tray 300 to drain under gravity through the irrigation opening 303. The draining water is directed by the branch conduits 203 into the drainage conduit 202. The drainage conduit 202 may then direct the water to an area to be re-treated and re-introduced into the irrigation system 200.

To perform subsequent water supply and drainage operations, the above described steps can be repeated.

Once the crops are ready to be harvested, the grow trays 300 are removed from the support structure 100.

As mentioned above, the water supply and drainage for each branch conduit 203 may be controlled independently to the other branch conduits 203. Therefore, the grow trays 300 on different levels 101 of the support structure 100 may be treated as separate batches and water may be supplied and drained at different times for each batch. For example, when the supply conduit 201 is filled with water, only a subset of the supply valves 206 may be opened to deliver water to the grow trays 300 on a particular level or levels 101 of the support structure 100. Similarly, only a subset of the drainage valves 207 may be opened to drain water from the grow trays 300 on a particular level or levels 101 of the support structure 100.

Furthermore, if each supply valve 206 is configured and arranged to selectively block fluid communication through the supply conduit 201 as well as selectively block fluid communication from the supply conduit 201 to the branch conduit (e.g. a three-way valve located at the intersection between the supply conduit 201 and the branch conduit 203), then the supply conduit 201 does not need to completely fill with water when only a subset of the branch conduits 203 is to be filled. For example, if only a particular branch conduit 203 is to be filled, then its supply valve 206 can block water entering the top of the supply conduit 201 from flowing past that branch conduit 203 so that water can flow directly into the branch conduit 203 without first having to fill the supply conduit 201 from the bottom.

By providing each grow tray 300 with a tray conduit 204 for both fluid supply and drainage, the amount of pipework in the irrigation system 200 and the complexity of the irrigation system 200 can be reduced.

By supplying fluid directly into each growing tray from below, the volume of water supplied to each grow tray 300 may be more precisely controlled. As a result, the present system may provide more optimal crop growth and more efficient use of water. Furthermore, the flow rate of fluid into and out of the grow trays 300 can be controlled such that the flow regime is laminar, which is less likely to disturb the seeds, the crops or the growing medium in the grow trays 300 compared to top-down watering systems, which may be more turbulent. For example, the flow rate of fluid into the supply conduit 201, the diameters of the tray conduits 204 and the irrigation openings 303, etc. can be chosen to provide laminar flow into and out of each grow tray 300.

Top-down watering systems also tend to rely on small drainage holes in the base 301 of the grow trays 300 so that the rate of water supply is higher than the rate of water drainage in order to keep a sufficient amount of water in the grow trays 300. However, small drainage holes can be easily blocked by debris. In the present system, the same tray opening is used for both fluid supply and fluid drainage and both operations do not happen at the same time. Therefore, the opening in the tray can be made relatively large, which reduces the risk of blockage, and even if the opening becomes blocked, the blockage will likely be dislodged during the next fluid supply operation.

Although the irrigation system 200 shown in FIG. 3 has a single supply conduit 201 and a single drainage conduit 202 positioned at opposite ends of the support structure 100, the irrigation system 200 is not limited to this arrangement and may instead comprise a plurality of supply conduits and/or a plurality of drainage conduits, particularly if the support structure 100 defines a large number of tray-receiving locations 102 on each level.

For example, the support structure 100 and irrigation system 200 shown in FIG. 3 may be considered as a repeatable unit, i.e. the system may have a plurality of pairs of supply and drainage conduits. Alternatively a plurality of drainage conduits may be coupled (via branch conduits) to a single supply conduit, or a plurality of supply conduits may be coupled (via branch conduits) to a single drainage conduit.

Furthermore, the grow trays 300 on a particular level of the support structure 100 may be served by a plurality of branch conduits, rather than just one branch conduit.

Although the irrigation system 200 shown in FIG. 3 has separate supply and drainage conduits, it will be appreciated that a common service conduit could function as both the supply conduit and the drainage conduit. In this case, a single set of valves could couple each branch conduit 203 to the service conduit, which would be opened and closed for both fluid supply operations and fluid drainage operations. A valve may be provided at the bottom of the service conduit (below the bottom-most level 101 of the support structure 100) so that the service conduit may be selectively closed to prevent fluid draining out of the service conduit during fluid supply operations.

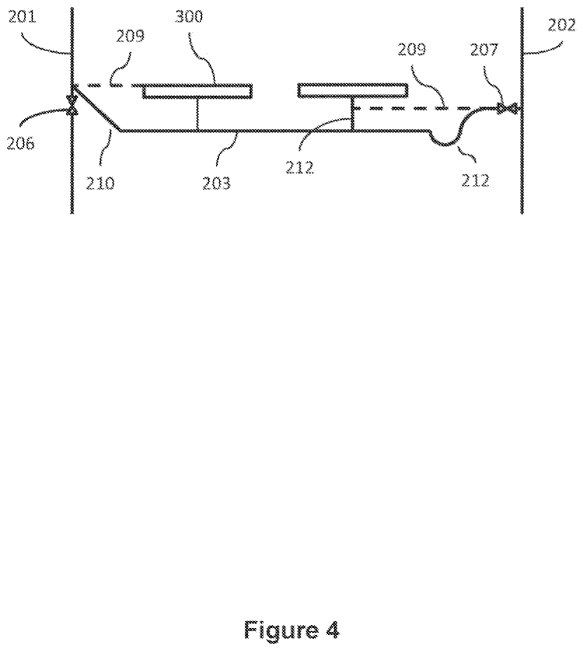

FIG. 4 is a schematic diagram of a variation of the irrigation system 200 of FIG. 3 that allows some water to be retained in each branch conduit 203 after a drainage operation. By retaining some water in the branch conduits 203 after a drainage operation, the next supply operation is faster because the time required to fill the branch conduits 203 and tray conduits 204 with water before the grow trays 300 can begin to fill with water is reduced. This may be particularly advantageous when each level 101 of the support structure 100 contains many tray-receiving locations 102 and each branch conduit 203 is relatively long.

The irrigation system of FIG. 3 and the irrigation system of FIG. 4 differ in the configuration of the branch conduits 203.

FIG. 4 shows a branch conduit 203 fluidly coupled to a plurality of tray conduits 204, which are fluidly coupled to a plurality of grow trays 300 located on the support structure 100 (not shown). The branch conduit 203 is further fluidly coupled between a supply conduit 201 and a drainage conduit 202. As before, a supply valve 206 is coupled between the supply conduit 201 and the branch conduit 203 and a drainage valve 207 is coupled between the drainage conduit 202 and the branch conduit 203. Although only one branch conduit 203 is shown in FIG. 4, the irrigation system may comprise a plurality of similar branch conduits 203 serving different levels 101 of the support structure 100.

The branch conduit 203 defines a drainage overflow level 211 at or near the drainage conduit 202. Above the drainage overflow level 211, water can flow from the branch conduit 203 into the drainage conduit 202 under gravity until the drainage overflow level 211 is reached. Conversely, below the drainage overflow level 211, water cannot flow from the branch conduit 203 into the drainage conduit 202.

The drainage overflow level 211 is higher than the branch conduit 203 and lower than the bottom of the grow trays 300 when located in the tray-receiving locations 102 (i.e. the drainage overflow level 211 is positioned in the vertical direction between the branch conduit 203 and the bottom of the grow trays 300). In this way, water may completely drain out of the grow trays 300 under gravity, but some water will remain within the branch conduit 203 and the tray conduits 204 at the drainage overflow level 211. Therefore, during the next water supply operation, the time lag between the supply valves 206 opening and water filling the grow trays 300 can be reduced because a smaller volume of water is required before the water starts to fill the grow trays 300. If the drainage overflow level 211 is just below the bottoms of the grow trays 300, then the time lag may be substantially negligible.

The drainage overflow level 211 may be defined by a first bent portion 210 of the branch conduit 203. For example, the drainage overflow level 211 may be defined by U-bend or an S-bend, or a portion inclined to the horizontal, e.g. at 45 degrees or any other angle above 0 degrees, up to and including 90 degrees.

The branch conduit 203 may also define a similar supply overflow level 209 at or near the supply conduit 201. The supply overflow level 209 may be higher than the predetermined level of the grow trays 300 coupled to the branch conduit 203. The supply overflow level 209 helps to prevent water from draining out of the branch conduits 203 into the supply conduit 201 and therefore allows for an arrangement where the supply valves 206 are located on the supply conduit 201, just below the entrance to each branch conduit 203, as shown in FIG. 4. This supply valve 206 arrangement allows each branch conduit 203 to be individually supplied with water by opening the supply valves 206 above the branch conduit 203 to be supplied, and closing the supply valve 206 just below the branch conduit 203 to be supplied. This supply valve arrangement also allows for two-way valves to be used (e.g. butterfly valves), which are cheaper compared to, for example, three-way valves at the intersections between the branch conduits 203 and the supply conduit 201.

The supply overflow level 209 may be defined by a second bent portion 212 of the branch conduit 203. The supply overflow level may be defined by U-bend or an S-bend, or a portion inclined to the horizontal, e.g. at 45 degrees or any other angle above 0 degrees, up to and including 90 degrees.

The provision of the supply overflow level 209 is independent of the drainage overflow level 211. Each branch conduit 203 may have a drainage overflow level 211 and/or a supply overflow level 209.

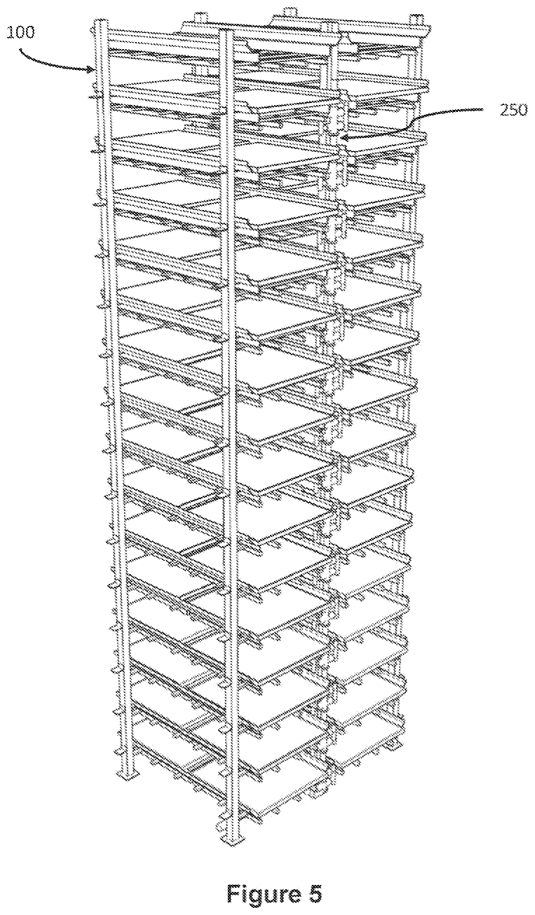

FIG. 5 shows an alternative farming system which does not require fluid supply and drainage into each branch conduit 203 to be actively controlled.

The support structure 100 shown in FIG. 5 is the same as the support structure 100 shown in FIGS. 1 and 2 and will therefore not be described in any further detail.

Irrigation system 250 comprises a common service conduit 251 for both supplying water to and draining water from the grow trays 300 (i.e. the service conduit 251 acts as both the supply conduit and the drainage conduit 202 of the irrigation system 200 of FIG. 3).

The service conduit 251 extends substantially vertically between the levels 101 of the support structure 100 and may be mounted to one of the vertical members 103 of the support structure 100 for support. At the bottom of the service conduit 251, below the bottom-most level of the support structure 100, a drainage valve (not shown) is provided for selectively closing the service conduit 251 to prevent water from draining out of the service conduit 251.

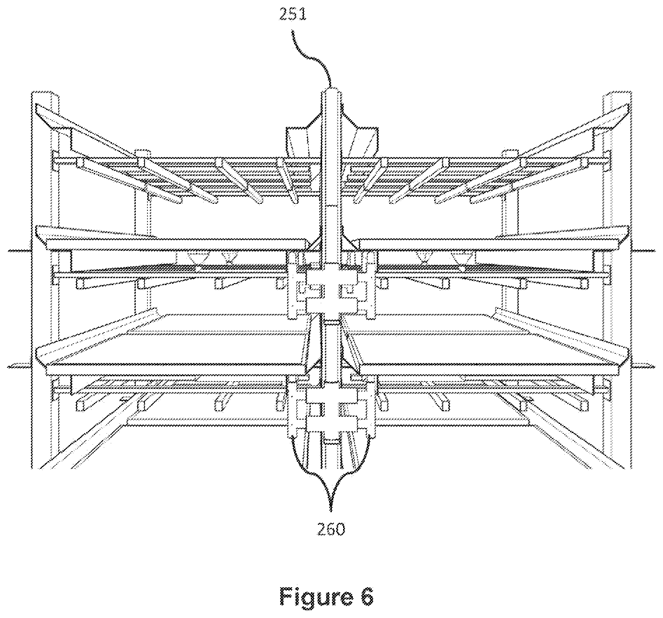

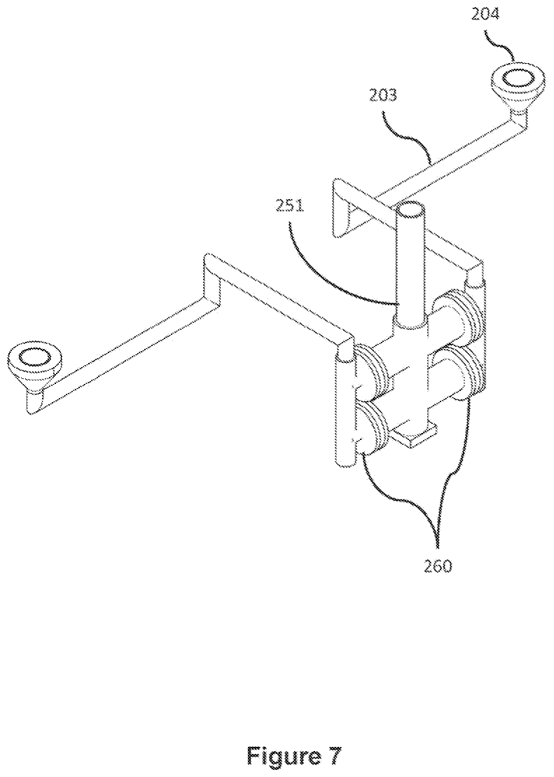

FIG. 6 is a front view of the system of FIG. 5, which shows each level 101 of the support structure 100 and the irrigation system 250 in more detail. The components of the irrigation for servicing grow trays 300 at one level 101 of the support structure 100 are shown in isolation in FIG. 7.

Similar to the irrigation system 200 shown in FIG. 3, irrigation system 250 comprises tray conduits 204 couplable to the bottom of the grow trays 300 and branch conduits 203 coupled between the tray conduits 204 and the service conduit 251. Although FIGS. 5-7 show one branch conduit 203 for each tray conduit 204, the irrigation system 250 is not limited to this arrangement and one branch conduit 203 may be coupled to one or more tray conduits 204.

Similar to the irrigation system shown in FIG. 4, the branch conduits 203 of irrigation system 250 may define a drainage overflow level at or near the service conduit 251 for the purposes of retaining water in the branch conduit 203 after drainage.

Each branch conduit 203 is coupled to the service conduit 251 via a selector valve assembly 260. At each level 101 of the support structure 100, the service conduit 251 is coupled to two selector valve assemblies arranged on opposing sides of the service conduit 251. The two selector valve assemblies can be formed as a single unit, as shown in FIG. 7. However, the irrigation system 250 is not limited to this arrangement. For example, at each level 101 of the support structure 100, the service conduit 251 may be coupled to only one selector valve assembly 260 or more than two selector valve assemblies, depending on the number of branch conduits 203 coupled to the service conduit 251 at that level 101.

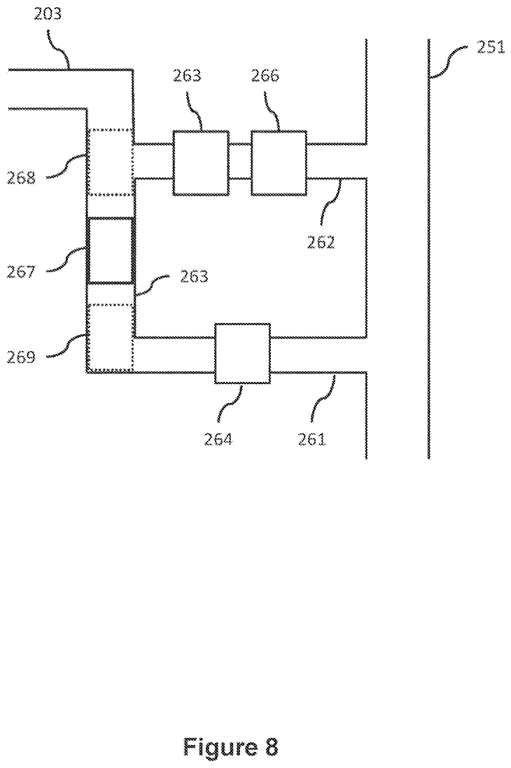

FIG. 8 is a schematic view of the selector valve assembly 260. The selector valve assembly 260 comprises three fluid channels 261, 262, 263. A supply channel 261 and a drain channel 262 are both coupled at one end to the service conduit 251. The supply channel 261 and the drain channel 262 extend substantially parallel to each other and are spaced apart. A flow-selector channel 263 extends substantially perpendicular to the supply and drain channels 261, 262 and is fluidly coupled between them. The flow-selector channel 263 is further fluidly coupled to a branch conduit 203. In use, the supply and drain channels 261, 262 are orientated substantially horizontally and the supply channel 261 is arranged vertically below the drain channel 262. The flow-selector channel 263 is orientated substantially vertically and is coupled to the branch conduit 203 at the top of the flow-selector channel 263.

The supply channel 261 comprises a supply flow regulator 264 for regulating the flow rate of fluid flowing through the supply channel 261 to a predetermined supply flow rate.

The drain channel 262 comprises a drainage flow regulator 265 configured to regulate the flow rate of fluid through the drain channel 262 to a predetermined drainage flow rate.

The predetermined supply flow rate may be different to the predetermined drainage flow rate. For example, the predetermined supply flow rate may be higher or lower than the predetermined drainage flow rate.

The drain channel 262 further comprises a non-return valve 266 configured to allow water to flow through the drain channel 262 towards the service conduit 251 but prevent flow in the opposite direction.

The flow-selector channel 263 comprises a selector member 267 vertically movable within the slow-selector channel between a supply position 268 and a drain position 269. The supply position 268 is at the top of the flow-selector channel 263 and the drain position 269 is at the bottom of the flow-selector channel 263.

In the supply position 268, fluid communication between the supply channel 261 and the flow-selector channel 263 is open and fluid communication between the drain channel 262 and the flow-selector channel 263 is blocked. In the drain position 269, fluid communication between the drain channel 262 and the flow-selector channel 263 is open and fluid communication between the supply channel 261 and the flow-selector channel 263 is blocked

The selector member 267 is freely movable within the flow-selector channel 263 between the supply position 268 and drain position 269 so that the selector member 267 may be urged to one of the supply and drain positions 268, 269 depending on the direction of fluid flow through the flow-selector channel 263.

The selector member 267 and/or the channels 261, 262, 263 may be shaped or comprise geometric features that contact or cooperate with each other when the selector member 267 is in the supply position 268 or the drain position 269 so as to block fluid communication between the channels as appropriate. In the supply position 268, the selector member 267 may be urged against or cooperate with a supply seat to provide a seal between the flow-selector channel 263 and the drain channel 262. Similarly, in the drain position 269, the selector member 267 may be urged against or cooperate with a drain seat to provide a seal between the flow-selector channel 263 and the supply channel 261. The supply seat and/or the drain seat may comprise an elastomeric member, e.g. an O-ring.

When the selector valve assembly 260 is empty of water, the selector member 267 may tend to rest in the drain position 269 due to gravity.

The selector member 267 may have a cylindrical shape with a diameter smaller than the diameter of the flow-selector channel 263 so that there is a circumferential gap between the selector member 267 and the wall of the selector valve assembly 260 defining the flow-selector channel 263.

The selector valve assembly 260 is configured such that when water enters the supply channel 261 from the service conduit 251 and flows to the flow-selector channel 263, the force of the water against the selector member 267 is able to urge the selector member 267 upwards 1o towards the supply position 268. Once the selector member 267 is at the supply position 268, the continued force of the water entering the supply channel 261 keeps the selector member 267 at the supply position 268 so that water cannot flow from the flow-selector channel 263 into the drain channel 262. At the same time, water from the supply channel 261 may now flow into the branch conduit 203 via the flow-selector channel 263 (e.g. via the above-mentioned circumferential gap).

Conversely, when water enters the top of the flow-selector channel 263 from the branch conduit 203, the force of the water flowing against the top of the selector member 267 urges the selector member 267 to the drain position 269 so that water can flow from the flow-selector channel 263 into the drain channel 262, but not into the supply channel 261.

The selector member 267 may be denser than water so that when water in the irrigation system 250 is at rest, the selector member 267 rests in the drain position 269. However, the selector member 267 should be light enough so that it can be urged to the supply position 268 by the force of the water entering the supply channel 261 from the service conduit 251.

To facilitate the upward urging of the selector member 267 from the drain position 269 to the supply position 268, the supply channel 261 may be coupled to the flow-selector channel 263 vertically below the flow-selector channel 263 so that the water can push against the bottom surface of the selector member 267 when water enters the supply channel 261 from the service conduit 251. The bottom surface of the selector member 267 may be recessed to further facilitate the upward urging of the selector member 267 when water is pushing against the bottom surface of the selector member 267.

The flow-selector channel 263 may comprise an annular drain seat at the bottom of the flow-selector channel 263 having an opening smaller than the diameter of the selector member 267. Thus, when water is entering the flow-selector channel 263 from the branch conduit 203 and the selector member 267 is being urged downwards against the drain seat, a seal can formed between the flow-selector channel 263 and the supply channel 261. However, when water is entering the supply channel 261 from the service conduit 251, the water is still able to push against the bottom surface of the selector member 267 via the central opening in the annular drain seat.

A method of using the irrigation system 250 to supply water to and drain water from grow trays 300 placed in the tray-receiving locations 102 of the support structure 100 will now be described.

Before first use of the irrigation system 250, the service conduit 251, the selector valve assemblies 260 and the branch conduits 203 may be empty of water. The selector member 267 of each selector valve assembly 260 is resting in the drain position 269 due to gravity.

The drainage valve at the bottom of the service conduit 251 is closed to prevent water from draining out of the service conduit 251. Water is supplied into the service conduit 251 from the top and the service conduit 251 fills with water.

Once the water level in the service conduit 251 reaches above a selector valve assembly 260, water in the service conduit 251 may enter the selector valve assembly 260. If the predetermined supply flow rate is higher than the predetermined drain flow rate, then water will tend to enter the selector valve assembly 260 via the supply channel 261 instead of the drain channel 262 because the supply channel 261 offers the path of least resistance. Regardless, the non-return valve 266 in the drain channel 262 can prevent water entering the selector valve assembly 260 via the drain channel 262.

The flow rate of water being supplied into the service conduit 251 may be significantly greater than the predetermined supply flow rate of the selector valve assemblies 260 so that the service conduit 251 will completely fill with water before any significant amount of water has begun to enter the valve assemblies on the bottom levels 101 of the support structure 100. Thus, water may enter the valve assemblies at each level 101 of the support structure 100 substantially simultaneously.

Once water from the service conduit 251 enters the supply channel 261 of a selector valve assembly 260, the flow of water from the supply channel 261 towards the flow-selector channel 263 urges the selector member 267 upwards to the supply position 268. This allows water to flow from the supply channel 261 into the flow-selector channel 263, where it can then flow into a grow tray 300 via the branch and tray conduits 204 coupled to the flow-selector channel 263.

As water continues to be supplied to the service conduit 251, water continues to fill the grow trays 300 until a predetermined water level above the base 301 of the grow trays 300 is reached. Once the predetermined water level is reached, the water supply to the service conduit 251 is stopped.

At this point, the water in the irrigation system 250 is at rest and the water in the grow trays 300 remains held in the grow trays 300. The water is held in this state for a predetermined amount of time (e.g. on the order of minutes or hours) to allow the roots of the crops in the grow trays 300 to absorb the water they require for optimum growth.

In this hold state, the selector member 267 sinks down to the drain position 269. The non-return valve 266 in the drain channel 262 helps to prevent the water in the upper grow trays 300 from flooding the lower grow trays 300 via the drain channels 262.

To subsequently drain the water from the grow trays 300, the drainage valve at the bottom of the service conduit 251 is opened. This allows the water in each grow tray 300 to drain out under gravity via the tray conduit 204 and branch conduit 203 into the flow-selector channel 263 of the selector valve assembly 260. The force of the water flowing from the branch conduit 203 into the top of the flow-selector channel 263 urges the selector member 267 downwards into the drain position 269 so that water may flow from the flow-selector channel 263 to the drain channel 262 and then into the service conduit 251, where it may be directed to an area to be re-treated and re-introduced into the irrigation system 250.

Once the water has drained from the grow trays 300, the drainage valve may be closed and the cycle repeated again for the same batch of grow trays 300 or a new batch of grow trays 300.

Thus, irrigation system 250 may provide a more compact irrigation system with reduced components, where the flow of water into and out of each level of the storage structure may be passively controlled by the selector valve assemblies. The provision of the supply flow regulator 264 and the drainage flow regulator 265 allows a desired water fill rate and drain rate to be chosen respectively. For example, the supply and drainage predetermined flow rates may be chosen so that the flow of water into and out of the grow trays 300 is laminar. Only the water supply into the service conduit 251 and a single drainage valve at the bottom of the service conduit 251 may be actively controlled for water supply and drainage.

Grow Tray

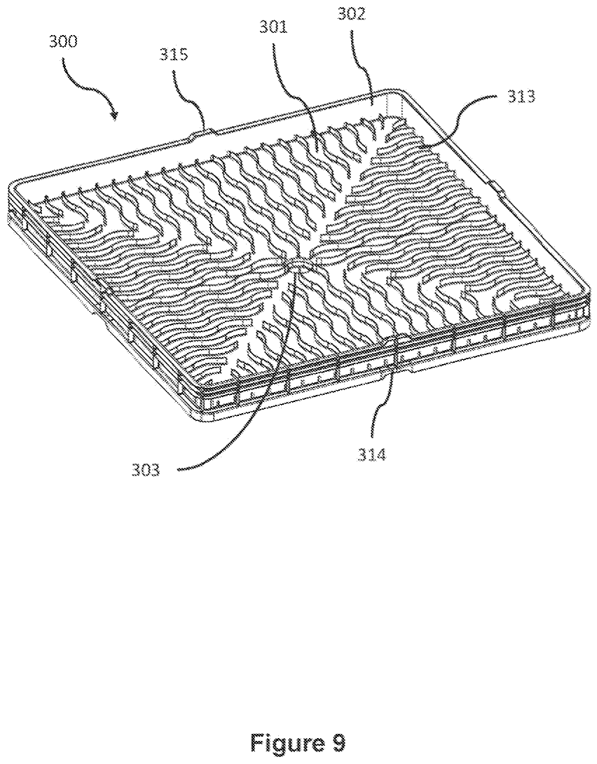

FIG. 9 shows a perspective view of a first example grow tray 300 for use with the support structure 100 and irrigation systems 200, 250 described above. The grow tray 300 can be made from plastic (e.g. a thermoplastic such as HDPE or nylon) and can be formed by known plastic moulding processes, e.g. injection moulding. In use, the grow tray 300 can contain a growing medium on which crops are grown from seed. The grow tray 300 may be used for hydroponic crop growth. Typical growing media for hydroponic growth include mineral wool (e.g. ROCKWOOL™), perlite, vermiculite, coir, clay pellets, etc. The grow tray 300 is particularly suitable for use with growing media in the form of a sheet, e.g. a mineral wool sheet.

The grow tray 300 comprises a rectangular base 301 and a perimeter wall 302 extending around the base 301 to form an open tray. The illustrated grow tray 300 has a square base (i.e. a regular rectangular base) but the base 301 may also have an irregular rectangular shape, or another shape (e.g. or polygons or a circle).

The centre of the base 301 comprises an irrigation opening 303 extending through the base 301 that allows fluid from the irrigation system to pass in and out of the grow tray 300. When a grow tray 300 is placed in a tray-receiving location 102 on the support structure 100, the bottom of the base 301 couples to a tray conduit of the irrigation system so that the irrigation opening 303 and the tray conduit 204 are aligned to allow fluid communication between the grow tray 300 and the tray conduit 204 via the irrigation opening 303. The irrigation opening 303 may be the only opening in the grow tray 300 that fluidly communicates with the irrigation system in use.

The irrigation opening 303 does not necessarily need to be at the centre of the base 301. The irrigation opening 303 may instead be at an edge of the base 301, or a corner of the base 301, or anywhere else on the base 301. However, a central irrigation opening 303 may advantageously provide more uniform filling and drainage across the base 301. The irrigation opening 303 may be sized so that the flow of water entering and leaving the grow tray 300 is substantially laminar. The diameter of the irrigation opening 303 may, for example, be between approximately 50 mm and 60 mm.

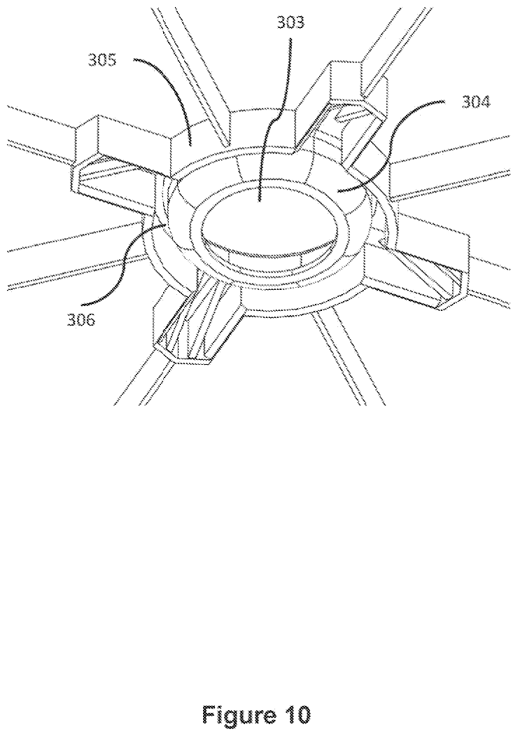

FIG. 10 is a bottom view of the grow tray 300 showing the irrigation opening 303. The bottom side of the base 301 comprises a coupling feature surrounding the irrigation opening 303 for coupling to a corresponding coupling feature on the tray conduit 204. The coupling feature on the grow tray 300 comprises a toroidal protrusion 304 encircling the irrigation opening 303 and may in itself define the opening. The toroidal protrusion 304 has a curved cross-section, e.g. a truncated circular cross-section, such that the protrusion 304 has an annular dome shape.

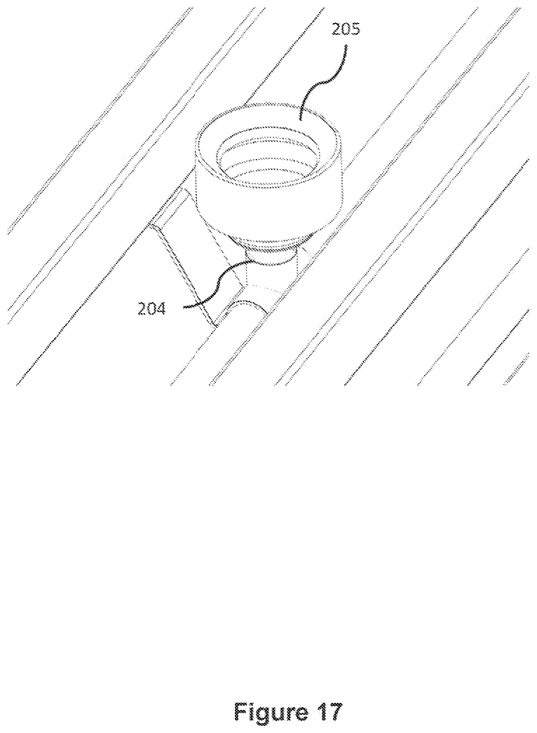

The corresponding coupling feature (shown in FIG. 17) on the tray conduit 204 comprises a complementary toroidal recess encircling the opening at the end of the tray conduit 204. The toroidal recess may have a curved cross-section, e.g. a truncated circular cross-section, such that the recess has an annular cup shape.

The toroidal protrusion 304 of the grow tray 300 or the toroidal recess of the tray conduit 204 may further comprise an elastomeric member (e.g. an O-ring) for providing a better seal between the tray conduit 204 and the grow tray 300.

The toroidal coupling between the grow tray 300 and the tray conduit 204 allows for a successful coupling even if the grow tray 300 is slightly misaligned with the tray conduit 204 when placing the grow tray 300 into the tray-receiving location 102. For example, the toroidal protrusion 304 and the toroidal recess are still able to cooperate with other even if the grow 1o tray 300 and the tray conduit 204 are slightly offset in a horizontal direction, at any rotational orientation, or if the grow tray 300 is slightly inclined to the horizontal.

Instead of the toroidal protrusion 304 being provided on the grow tray 300 and the toroidal recess being provided on the tray conduit 204, the toroidal recess could instead be provided on the grow tray 300 and the toroidal protrusion 304 could be provided on the tray conduit 204.

The bottom side of the base 301 of the grow tray 300 may further comprise a wall 305 encircling the toroidal protrusion 304. The wall 305 is radially spaced from the toroidal protrusion 304 to form a circumferential groove 306 that can receive the end of the tray conduit 204 when the tray conduit 204 is coupled to the grow tray 300. The groove 306, bordered in the inner radial direction by the toroidal protrusion 304 and in the outer radial direction by the wall 305, may add stability to the coupling and may help to avoid the tray conduit 204 moving relative to the grow tray 300 once they have coupled together. Instead of providing wall 305 to define the groove 306, the groove 306 may instead be defined as a recess in the bottom side of the base 301 itself.

The base 301 further comprises a plurality of ribs 313 upstanding from the top side of the base 301. The top of the ribs 313 provides a substantially horizontal surface for supporting a sheet of growing medium in a substantially horizontal orientation. By supporting the growing medium on top of the ribs 313, the growing medium is raised off the base 301. This facilitates fluid transport across the base 301 and allows the roots of the crops to be suspended, which may be beneficial for crop growth.

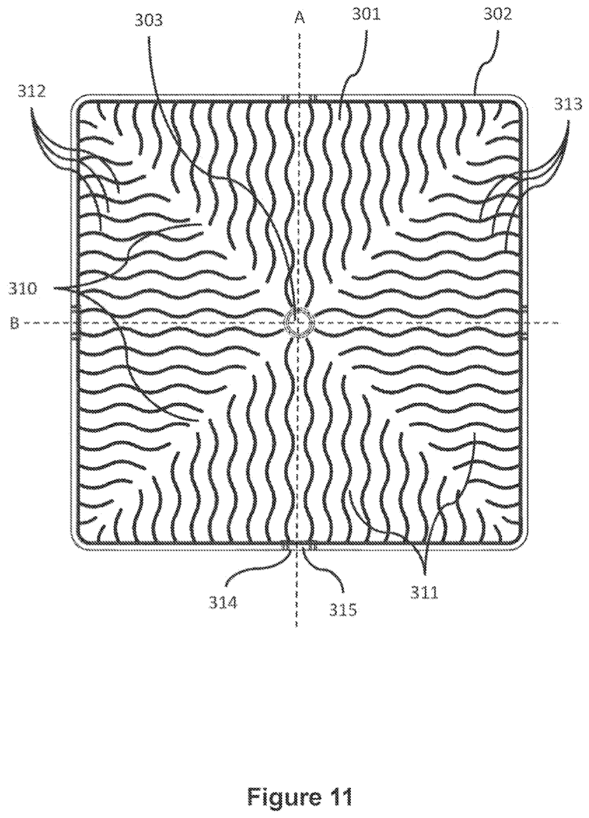

FIG. 11 is a top-down view of the grow tray 300 showing the arrangement of the ribs 313.

The base 301 comprises four main channels 310, each main channel 310 extending radially outward from the irrigation opening 303 to a corner of the base 301. The four main channels 310 divide the base 301 into four contiguous triangular sections 311, each triangular section 311 being bordered by two main channels 310 and a portion of the perimeter wall 302.

Each section 311 contains a subset of ribs 313 from the plurality of ribs 313. The ribs 313 within each section 311 are spaced apart to define branch channels 312 between adjacent ribs 313. Each rib 313 within each section 311 extends between one of the main channels 310 bordering the section 311 and the portion of the perimeter wall 302 bordering the section, such that each branch channel 312 is connected to one of the main channels 310 bordering the section, and each main channel 310 is connected to a plurality of branch channels 312.

The main channels 310 and the branch channels 312 provide fluid pathways across the base 301. In particular, when water enters the grow tray 300 from the irrigation opening 303, water may flow into the branch channel 312 via the main channels 310. Conversely, when water drains out of the grow tray 300, water may flow from each branch channel 312 to the irrigation opening 303 via the main channels 310.

The arrangement of main channels 310 and branch channels 312 helps to promote uniform distribution of water across the base 301 and helps to avoid dead zones. The arrangement also provides a relatively even distribution of space underneath the growing medium, which helps to avoid crop roots clumping together in particular areas of the grow tray 300.

The ribs 313 within each section 311 extend substantially parallel to each other so that the branch channels 312 within each section 311 extend substantially parallel to each other. The spacing between adjacent ribs 313 in each section 311 is substantially the same so that the branch channels 312 within each section 311 are substantially the same width as each other, which helps to further promote uniform distribution of water across the base 301 and promote even distribution of roots across the grow tray 300.

To promote greater and/or faster drainage of water into the irrigation opening 303, each section 311 may incline downwards towards the irrigation opening 303. The ribs 313 within each section 311 may extend substantially parallel to the direction of the incline of each section 311 so that water flowing through the branch channels can take the most direct path up and down the incline.

Each rib 313 has a wavy shape (e.g. a sinusoidal shape) when viewed from above. The wavy shape of the ribs 313 provides strength to the ribs 313 so that they are less likely to break off from the base 301 in a lateral direction compared to straight ribs.

The ribs 313 are not limited to the specific arrangement shown in FIG. 11. The arrangement may differ depending on the shape of the base 301, the number and position of the main channels 310, the arrangement of the ribs 313 within each section, etc.

In general, the base 301 comprises one or more main channels 310 extending between the irrigation opening 303 and the perimeter wall 302 (i.e. the one or more main channels 310 are in direct fluid communication with the irrigation opening 303). The one or more main channels 310 divide the base 301 into a plurality of contiguous sections 311. Each section 311 comprises a plurality of branch channels 312. Each branch channel 312 is connected to one of the main channels 310 to allow fluid communication between the irrigation opening 303 and the branch channels 312 via the one or main channels 310.

Each section 311 is bordered by at least one main channel 310 and a portion of the perimeter wall 302. Each branch channel 312 may extend between one of main channels 310 and the perimeter wall 302. Each branch channel 312 may extend to the perimeter wall 302, or each branch channel 312 may end before the perimeter wall 302 so that a perimeter channel is formed adjacent to the perimeter wall 302. The perimeter channel may further help to promote uniform distribution of water across the base 301.

The branch channels 312 within each section 311 may extend substantially parallel to each other. The branch channels 312 may have substantially the same width as each other to further promote uniform distribution of water across the base 301 and promote even distribution of roots across the tray.

The one or more main channels 310 and/or the branch channels 312 may extend substantially linearly, notwithstanding the fact that the boundaries of the channels may not be linear (e.g. if wavy ribs 313 are used to define the channels). A channel may be considered to extend substantially linearly if a linear path can be drawn between both ends of the channel.

The sections 311 may have substantially the same area as each other. The sections 311 may be symmetrically disposed about the irrigation opening 303. The sections 311 may be substantially triangular. The number of sections 311 formed by the main channels 310 may be one greater than the number of main channels 310.

The base 301 may be substantially flat (i.e. all sections 311 may lie in the same plane). Alternatively, to promote greater and/or faster drainage, each section 311 may incline downwards towards the irrigation opening 303. The slope of each section 311 may be approximately 1:50 or less. The slope of each section 311 may be at least approximately 1:100. The slope of each section 311 may be approximately between 1:100 and 1:50. The slope of each section 311 may be approximately 1:100, 1:90, 1:80, 1:70, 1:60 or 1:50. The branch channels 312 within each section 311 may extend substantially parallel to the direction of the incline of each section 311 so that water flowing through the branch channels 312 can take the most direct path up and down the incline.

The width of the main channels 310 may be between approximately 20 mm and 40 mm, e.g. 30 mm. The width of the branch channels 312 may be between approximately 40 mm and 60 mm, e.g. 50 mm.

As an example of an arrangement having one main channel 310, the irrigation opening 303 may be disposed at a corner of the base 301, with the main channel 310 extending from the irrigation opening 303 to an opposing corner of the base 301.

In the case where the base 301 comprises a plurality of main channels 310, each main channel 310 may extend from the irrigation opening 303 to a respective corner of the base 301. Alternatively, each main channel 310 may extend to a respective edge of the base 301.

The base 301 may comprise upstanding ribs 313 arranged in each section. The ribs 313 may be spaced apart so that each branch channel is defined between two adjacent ribs 313. The top of the ribs 313 may provide a substantially horizontal surface for supporting a sheet of growing substrate in a substantially horizontal orientation. The height of the ribs 313 may be between approximately 15 mm and 30 mm.

If each section 311 is inclined towards the irrigation opening 303, the height of the ribs 313 may increase towards the irrigation opening 303 to maintain the substantially horizontal surface provided by the top of the ribs 313.

Each rib 313 may have a wavy shape (e.g. a sinusoidal shape) when viewed from above. For wavy ribs 313, references in this description to the direction or orientation of the ribs 313 refer to the direction or orientation of a neutral line extending linearly between the peaks and troughs of the wave shape. The wavy shape of the ribs 313 provides strength to the ribs 313 so that they are less likely to break off from the base 301 in a lateral direction compared to straight ribs. However, the ribs 313 are not limited to being a wavy shape and may be straight ribs 313 or some other shape, provided that they are spaced so that branch channels 312 are defined between adjacent ribs 313.

Instead of the branch channels 312 being defined by upstanding ribs 313, the one or more main channels 310 and the branch channels 312 may be defined by grooves formed in the base 301. The top surface of the base 301 then provides a substantially horizontal surface for supporting a sheet of growing substrate in a substantially horizontal orientation.

The above-described arrangement of main channels 310 and branch channels 312 may be used in grow trays 300 that are not rectangular. For example, a base having an n-sided polygon shape (where n is an integer greater than or equal to 3) may have n number of main channels 310, each main channel 310 extending to a respective corner or edge of the base 301. Alternatively, the tray may have a circular base 301, with one or more main channels 310 dividing the base 301 into a plurality of segments.

As mentioned above in relation to the irrigation systems 200, 250, the grow trays 300 may be filled with water until the water in the grow trays 300 reaches a predetermined water level. This predetermined water level may be above the top of the ribs 313 (or grooves) so that at least a portion of the growing medium is submerged in water. For example, the predetermined water level may be approximately 1 mm to 5 mm above the top of the ribs 313, more particularly approximately 2 mm to 5 mm above the top of the ribs 313, or more particularly approximately 3 mm to 4 mm above the top of the ribs 313.

As mentioned above in relation to the support structure 100, each tray-receiving location 102 may comprise locating features configured to cooperate with corresponding locating features on a grow tray 300 to help locate the grow tray 300 into the correct position with respect to a tray conduit 204 of the irrigation system and to help prevent horizontal movement of the grow tray 300 once in the tray-receiving location 102.

For example, as shown in FIG. 8, the grow tray 300 comprises four locating recesses 314 disposed on the bottom of the base 301. Each locating recess 314 is disposed at or near an edge of the base 301.

Each tray-receiving location 102 may comprise corresponding locating protrusions (not shown) which are received by the locating recesses 314 on the bottom of the grow tray 300 when placed in the tray-receiving location 102. The locating protrusions may be arranged on the horizontal members 104, for example.

Although the grow tray 300 in FIG. 9 comprises a locating recess 314 on all four edges of the base 301, the tray-receiving location 102 does not need to comprise a locating protrusion for each locating recess 314 of the grow tray 300. It is sufficient, for example, to provide an opposing pair of locating protrusions in each tray-receiving location 102 to engage with an opposing pair of locating recesses 314 of the grow tray 300. Even if the tray-receiving location 102 comprises only an opposing pair of locating protrusions, an advantage of providing a locating recess 314 at all four edges of the grow tray 300 is that the grow tray 300 does not need to be rotated to a particular orientation before being placed in a tray-receiving location 102 due to the rotational symmetry of the grow tray 300.

The locating recesses 314 and locating protrusions may have inclined side surfaces 316 (e.g. they may have a trapezoidal shape) so that the locating protrusions may self-locate into the locating recesses 314.

Instead of the grow tray 300 comprising locating recesses 314 and the tray-receiving location 102 comprising locating protrusions, the grow tray 300 may comprise locating protrusions and the tray-receiving location 102 may comprise complementary locating recesses.

At each tray-receiving location 102, the position of the locating protrusions relative to the tray conduit 204 is the same as the position of the locating recesses 314 relative to the irrigation opening 303 of the grow tray 300, so that once the grow tray 300 has been placed in a tray-receiving location 102 and the locating recesses 314 and protrusions have mated, the irrigation opening 303 and the tray conduit 204 should be aligned.

Each of the four locating recesses 314 extends parallel to a respective perimeter edge of the base 301. The four locating recesses 314 of the grow tray 300 are arranged into two diametrically opposed pairs. The midpoints of the locating recesses 314 in the first pair are aligned along a first axis, A, running through the centre of the irrigation opening 303 and perpendicularly through one of the pairs of opposing parallel edges of the base 301. The midpoints of the locating recesses 314 in the second pair are aligned along a second axis, B, running through the centre of the irrigation opening 303 and perpendicularly through the other pair of opposing parallel edges of the base 301.

In this way, the midpoints of the locating recesses 314 and the centre of the irrigation opening 303 will be aligned. Therefore, as long as the locating recesses 314 mate with the locating protrusions at a tray-receiving location 102, the irrigation opening 303 will be aligned with the tray conduit 204.

It is known that for some plastic manufacturing techniques, e.g. injection moulding, as the plastic cools after being moulded it may shrink in size causing distortion. This shrinkage effect may cause the locating recesses 314 of the grow tray 300 to be offset from their expected design positions with respect to the irrigation opening 303, which may lead to the irrigation opening 303 being misaligned with the tray conduit 204 when the grow tray 300 is located in the tray-receiving location 102. The locating recesses 314 of the grow trays 300 mitigate against any manufacturing flaws, even if the grow tray 300 shrinks in the X and/or Y direction, and regardless of the amount of plastic shrinkage that has taken place.

For a rectangular base 301 with a central irrigation opening 303, each locating recess 314 is symmetrically arranged about the midpoint of a corresponding edge of the base 301. However, if the irrigation opening 303 is not located at the centre of the base 301, then the locating recesses 314 will be positioned elsewhere on the base 301 accordingly so that the midpoints of the locating recesses 314 and the centre of the irrigation opening 303 are aligned. The positions of the locating protrusions in the tray-receiving locations 102 with respect to the tray conduits 204 would also change accordingly.

As mentioned above, the grow tray 300 is not limited to having two pairs of opposing locating features 314. Only one pair of diametrically opposing locating features 314 may be provided, the midpoints of which are aligned along an axis running through the centre of the irrigation opening 303 and perpendicularly through a pair of opposing parallel perimeter edges of the base 301. The locating features also do not need to be arranged at the edge of the base 301, and may instead be arranged elsewhere on the base 301, or on the perimeter wall 302, for example.

The locating recesses 314 on the bottom of the grow tray 300 may also function as a stacking feature that allows the grow trays 300 to be vertically stacked. Being able to vertically stack the grow trays 300 is useful when storing or transporting grow trays 300. In addition, un-germinated seeds may be sowed in grow trays 300 which are then stacked and placed in an optimal environment to allow the seeds to germinate before loading the trays onto the support structure 100 of the present system for the next stage of crop growth.

As shown in FIG. 9, the grow tray 300 further comprises a plurality of stacking protrusions or castellations 315 upstanding from the top of the perimeter wall 302. For each locating recess 314, a complementary stacking protrusion 315 is provided. When the grow trays 300 are vertically stacked, the stacking protrusions 315 of a particular grow tray 300 are received in the locating recesses 314 of the grow tray 300 immediately above.

Similar to the locating recesses 314, each stacking protrusion 315 has inclined side surfaces (e.g. a trapezoidal shape) to allow the grow trays 300 to self-locate on top of each other when stacking them.

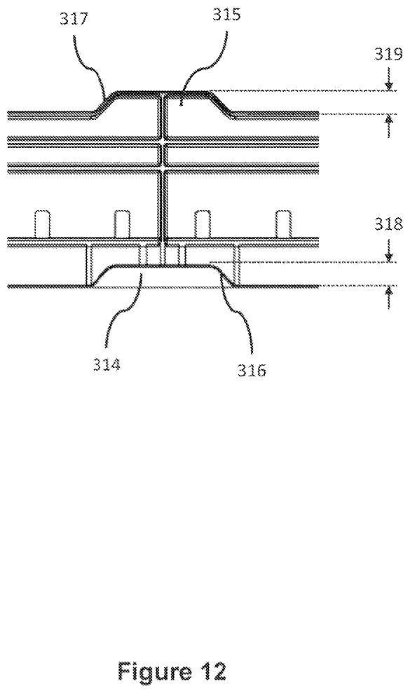

FIG. 12 shows a partial side view of the grow tray 300. The maximum height 319 of the stacking protrusions 315 may be larger than the maximum height 318 of the locating recesses 314 so that when the trays are vertically stacked, a vertical gap is formed between adjacent trays. The vertical gap may be between approximately 10 mm and 50 mm, or between approximately 20 mm and 40 mm, or between approximately 20 mm and 30 mm. The vertical gap may be approximately 10 mm, 20 mm, 30 mm, 40 mm or 50 mm.

The vertical gaps allow for air flow between stacked trays 300, which may be beneficial for seed germination. However, if vertical gaps between the stacked trays are not required, then the maximum heights of the stacking protrusions 315 and locating recesses 314 may be substantially the same. The stacking protrusions 315 and the locating recesses 314 also help to prevent the grow trays 300 from moving relative to each other in a horizontal direction once stacked.

It will be appreciated that if the bottom of the tray 300 instead comprised locating protrusions, then the top of the perimeter wall 302 would comprise complementary stacking recesses.

It will also be appreciated that, for the purposes of stacking, the protrusions and recesses on the top and bottom of the grow tray 300 are not limited to the arrangement shown in FIG. 9. For example, each edge of the grow tray 300 could comprise more than one protrusion or recess, or the protrusions and recesses could be located in the corners.

It will be appreciated that while the various aspects of the grow tray 300 described above (e.g. the coupling feature for coupling to a tray conduit 204, the channel arrangement, the locating features for locating the grow tray 300 on the support structure 100 and the stacking features) may work together to provide a grow tray 300 that is particularly suitable for use in the present farming system, each of the aspects may also exist independently of the other.

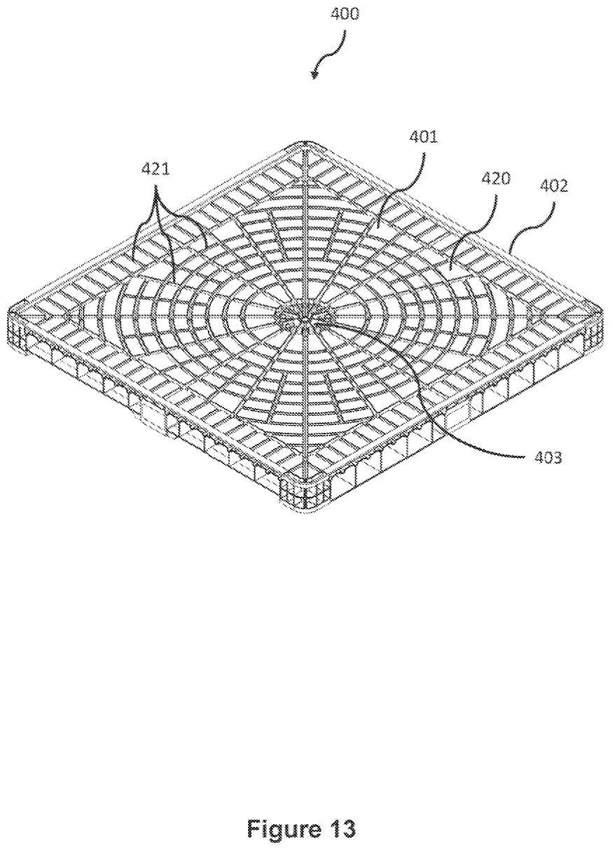

FIG. 13 shows a perspective view of a second example grow tray 400 for use with the support structure 100 and irrigation systems 200, 250 described above. Like the first grow tray 300, the second grow tray 400 can be made from plastic (e.g. a thermoplastic such as HDPE or nylon) and can be formed by known plastic moulding processes, e.g. injection moulding. In use, the grow tray 400 can contain a growing medium on which crops are grown from seed. The grow tray 400 may be used for hydroponic crop growth. Typical growing media for hydroponic growth include mineral wool (e.g. ROCKWOOL™), perlite, vermiculite, coir, clay pellets, etc. The grow tray 400 is particularly suitable for use with growing media in the form of a sheet, e.g. a mineral wool sheet.

Similar to the first grow tray 300, the second grow tray 400 comprises a square base 401 and a perimeter wall 402 extending around the base 401 to form an open tray. The centre of the base 401 comprises a circular irrigation opening 403 extending through the base 401 that allows fluid from the irrigation system to pass in and out of the grow tray 400.

The top-most surface 420 of the base 401 provides a substantially horizontal surface for supporting a sheet of growing medium in a substantially horizontal orientation. The base 401 comprises a plurality of grooves 421 in the top-most surface 420 which define a plurality of channels for holding fluid and facilitating fluid transport between the irrigation opening 403 and the rest of the base 401.

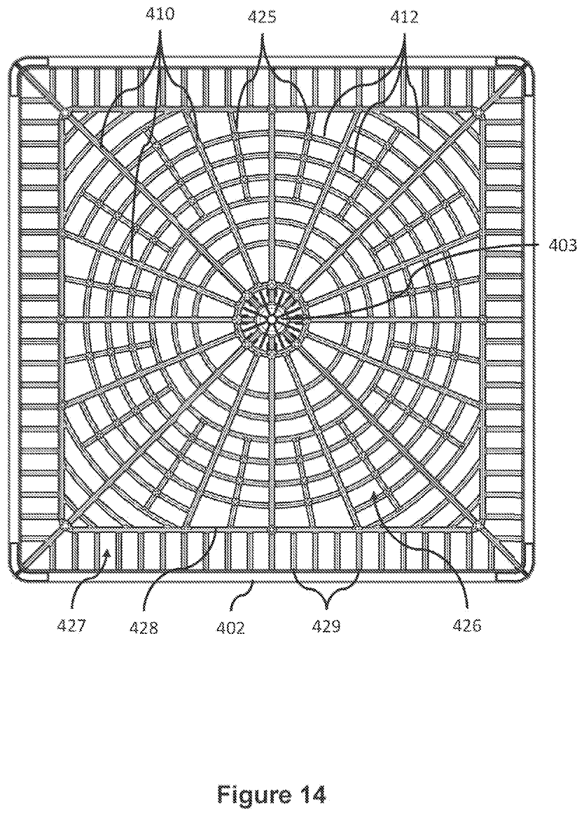

FIG. 14 is a top-down view of the grow tray 400 showing the arrangement of the channels. The base 401 comprises an inner portion 426 which comprises a plurality of primary channels 410 extending radially outwards from the irrigation opening 403 towards the perimeter wall 402. The primary channels 410 are regularly spaced in the circumferential direction. The base 401 further comprises a plurality of circumferentially extending secondary channels 412 that connect adjacent primary channels 410. Similar to the first grow tray 300, the primary channels 410 can be considered to divide the base into a plurality of contiguous sections, each section comprising a subset of the secondary channels 412. The primary channels 410 and the secondary channels 412 of the second grow tray 400 are synonymous with the main channels 310 and the branch channels 312 of the first grow tray respectively.

The secondary channels 412 are arranged to form a plurality of concentric rings that are spaced in the radial direction and centred on the irrigation opening 403. The base 401 optionally further comprises a plurality of radially extending tertiary channels 425 that extend between at least some of the concentric rings to connect secondary channels 412 that are adjacent to each other in the radial direction. The tertiary channels 425 are regularly spaced in the circumferential direction and are located between the primary channels 410. In this example, the tertiary channels 425 connect the secondary channels 412 in some of the outer concentric rings, but do not connect the secondary channels 412 in the inner concentric rings closest to the irrigation opening 403. This is because the secondary channels 412 in the outer concentric rings are longer than those in the inner concentric rings and therefore the tertiary channels 425 help to distribute fluid evenly between the longer secondary channels 412, which is not required for the secondary channels 412 in the inner concentric rings due to their shorter length.

This arrangement of primary, secondary and tertiary channels 410, 412, 415 forms a web-like pattern that facilitates even distribution of fluid across the base 401. In particular, the primary channels 410 distribute fluid to and from the irrigation opening, the secondary channels 412 distribute fluid between the primary channels 410 and the tertiary channels 415 distribute fluid between the secondary channels 412.

To further facilitate even distribution of fluid across the base 401, the primary, secondary and tertiary channels 410, 412, 415 can have different depths to each other. In the present example, the primary channels 410 are deeper than the secondary and tertiary channels 412, 415, i.e. the grooves forming the primary channels 410 are deeper with respect to the top-most surface 420 than the grooves forming the secondary and tertiary channels 412, 415. The primary channels may be twice as deep as the secondary channels, for example. The tertiary channels 415 may have the same depth as the secondary channels 412, or they may be shallower or deeper than the secondary channels 412.

The base 401 further comprises a perimeter portion 427 defined between the inner portion 426 and the perimeter wall 402. The perimeter portion 427 has a square annulus shape that surrounds the inner portion 426. The perimeter portion 427 comprises a primary perimeter channel 428 at the border between the perimeter portion 237 and the inner portion 426. The perimeter portion 427 further comprises regularly spaced secondary perimeter channels 429 extending perpendicularly between the primary perimeter channel 428 and the perimeter wall 402. This arrangement of channels 428, 429 in the perimeter portion 427 facilitates even distribution of fluid up to the perimeter wall 402. However, the perimeter portion 427 is optional and the web-like pattern of channels in the inner portion 426 could extend up to the perimeter wall 402. Similar to the channels in the inner portion 426, the primary and second perimeter channels 428, 429 can have different depths to each other to further facilitate even distribution of fluid. In the present example the primary perimeter channel 428 is deeper than the secondary perimeter channels 429. In particular, the primary perimeter channel 428 has the same depth as the primary channels 410 in the inner portion 426 and the secondary perimeter channels 429 has the same depth as the secondary channels 412 in the inner portion 426.

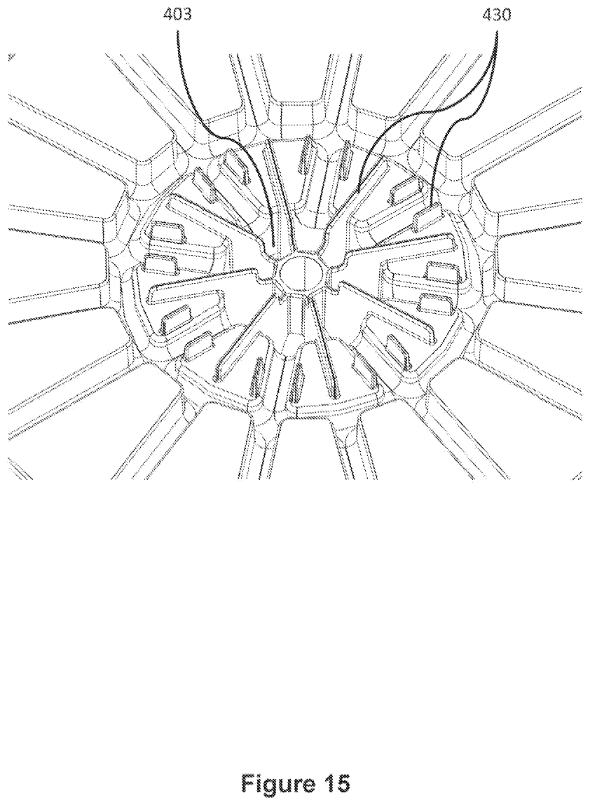

Similar to the first grow tray, the diameter of the irrigation opening 403 is sized so that the flow of water entering and leaving the grow tray 400 is substantially laminar. This may result in an irrigation opening 403 with a relatively large diameter. To provide support to a sheet of growing medium in the region directly above the irrigation opening 403, the base 401 further comprises radially extending fins 430 within and around the irrigation opening 403 that have a top surface that is approximately level with the top-most surface 420 of the base 401. The fins 430 are shown in more detail in FIG. 15.

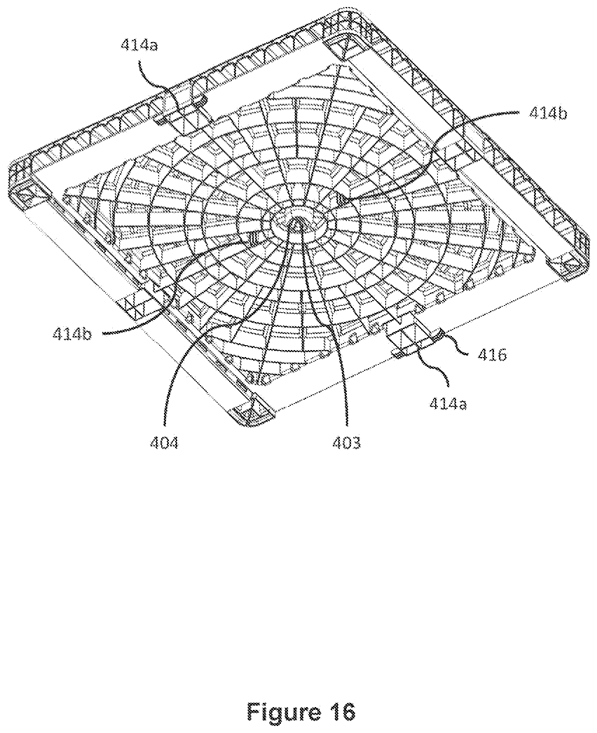

FIG. 16 shows the underside of the second grow tray 400. Similar to the first grow tray 300, the bottom side of the base 401 of the second grow tray 400 comprises a coupling feature in the form of a toroidal protrusion 404 encircling and defining the irrigation opening 403.

FIG. 17 shows a complementary toroidal recess 205 encircling the opening at the end of a tray conduit 204 for coupling to the toroidal protrusion 404 of the grow tray 400 (or the toroidal protrusion 304 of the grow tray 300). When the tray conduit 204 and the grow tray 400 are coupled together, the toroidal protrusion 404 of the grow tray 400 sits in the toroidal recess 205 of the tray conduit 204.

Referring back to FIG. 16, similar to the first grow tray 300, the second grow tray 400 comprises locating features 414a, 414b to help locate the grow tray 400 into the correct position in a tray receiving location 102 so that the grow tray 400 can couple to a tray conduit 204. In particular, the underside of the base 401 comprises a first pair of locating protrusions 414a diametrically opposed about the centre of the irrigation opening 403 and a second pair of locating protrusions 414b diametrically opposed about the centre of the irrigation opening. Similar to the first grow tray 300, the mid-points of the first pair of locating protrusions 414a and the centre of the irrigation opening 403 are aligned along a first axis, and the mid-points of the second pair of locating protrusions 414b and the centre of the irrigation opening 403 are aligned along a second axis that is perpendicular to the first axis.

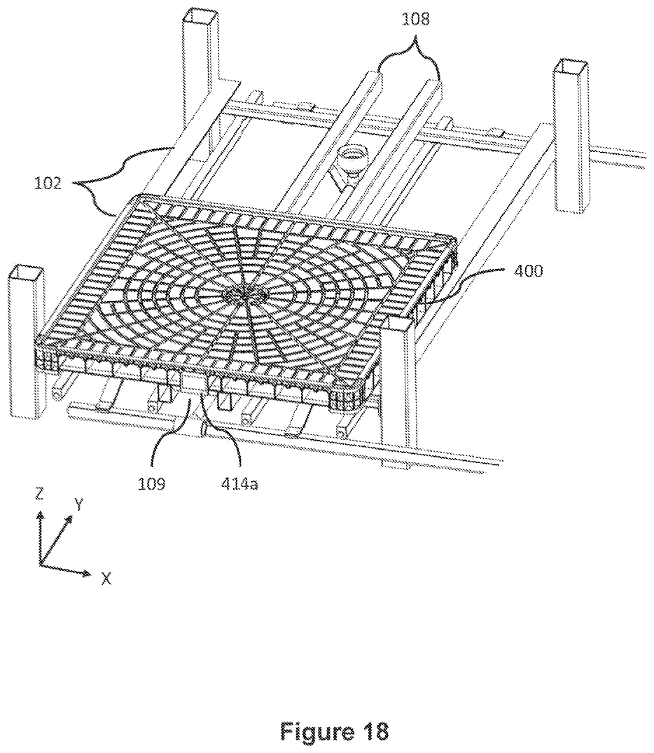

FIG. 18 shows a portion of the support structure 100 comprising an unoccupied tray receiving location 102 and an adjacent tray receiving location 102 occupied by a grow tray 400. Each tray receiving location 102 comprises a pair of parallel bars 108 extending in the X-direction. The parallel bars 108 are spaced apart in the Y-direction (with the tray conduit 204 located in between) to define a locating recess (gap) 109 between the parallel bars 108 for receiving the first pair of locating protrusions 414a of the grow tray 400. The parallel bars 108 therefore help to locate the grow tray 400 into the correct position in the Y-direction. The first pair of locating protrusions 414a of the grow tray 400 comprise inclined side surfaces 416 that can engage with the parallel bars 108 when the grow tray 400 is being loaded into the tray receiving location 102 to help locate the first pair of locating protrusions 414a into the locating recess 109.

To help locate the grow tray 400 into the correct position in the tray receiving location 102 in the X-direction, the tray receiving location 102 may further comprise locating recesses (not shown) for receiving the second pair of locating protrusions 414b. The locating recesses for receiving the second pair of locating protrusions 414b may be formed on the pair of parallel bars 108. Alternatively, the second pair of locating protrusions 414b may be omitted from the grow tray 400 and the tray receiving location 102 may comprise an end stop (not shown) that abuts against the rear side of the grow tray 400 when the grow tray 400 is pushed horizontally into the tray receiving location 102. The end stop may be positioned with respect to the tray conduit 204 such that when the rear side of the grow tray 400 is abutting against the end stop, the irrigation opening 403 is aligned with the tray conduit 204 in the X-direction.

In use with the irrigation system 200, 250, the second grow tray 400 functions in the same manner as the first grow tray 300. Fluid is delivered into the grow tray 400 from below via the irrigation opening 403. The fluid is then held in the grow tray for a predetermined period of time, before allowing the fluid to drain out from the irrigation opening 403.

The first and second grow trays 300, 400 may be placed in and removed from the tray-receiving locations 102 by lifting vehicles. For example, an automated or manually controlled lifting vehicle may lift a grow tray 300, 400 from a stack, move to a position next to the support structure 100 and place the tray in the desired tray-receiving location 102. When the grow tray 300, 400 is ready to be removed from the support structure 100, the lifting vehicle may move to the tray-receiving location 102 and lift the tray out of the tray-receiving location 102 and transport it elsewhere, e.g. to a harvesting station.

The first and second grow trays 300, 400 may comprise transport coupling features for cooperating with corresponding coupling features on a lifting vehicle so that the grow trays 300, 400 do not slide relative to the lifting vehicle while being lifted. For example, the grow tray 300, 400 may comprise protrusions on the bottom of the base 301, 401 that are received in recesses on a component of the lifting vehicle (e.g. in a lifting arm or platform), or vice versa. As another example, the bottom of the base 301, 401 of the tray may comprise one or more horizontally extending recesses or slots for receiving horizontally extending lifting arms of the lifting vehicle.

As explained above in relation to the support structure 100, each grow tray 300, 400 may also comprise a unique identifier, e.g. an RFID tag, that uniquely identifies each grow tray 300, 400 so that its position in the support structure 100 can be recorded and tracked. The unique identifiers for each grow tray 300, 400 may also be linked to the type of crop being grown in the grow tray 300, 400 and other variables such as time spent at a particular tray-receiving location 102.

The grow tray 300, 400 is intended to provide a single component for containing crops and for coupling directly to an irrigation system such that the grow tray 300, 400 may fluidly communicate directly with the irrigation system. The present grow tray 300, 400 may be simpler to manufacture and easier to clean, and less handling is required to place the grow trays 300, 400 onto a support structure 100. Furthermore, the volume of water entering the grow tray 300, 400 and being made available to the crops can be more precisely controlled.

Although some features of the grow tray of the present invention have been described in relation to the first grow tray 300 and other features have been described in relation to the second grow tray 400, the skilled person will appreciate that any of the features of the first grow tray 300 can be independently used with features of the second grow tray 400 and vice versa. For example, the channel arrangement of the first grow tray 300 can be used with the second grow tray 400 and vice versa, the stacking protrusions 315 and/or the locating recesses 314 of the first grow tray 300 can be used with the second grow tray 400 and vice versa, etc.

The detailed description of features of the first grow tray 300 that are similar or equivalent to the second grow tray 400 (e.g. the toroidal coupling feature, the alignment between the locating protrusions and the irrigation opening, shapes and dimensions of features, etc.) has not been repeated in full for conciseness, but is still applicable to the second grow tray 400.

The system and devices described above, with reference to the figures, allows for controlled provision of water to crops in a controlled indoor farming environment. Accordingly crop yields, quality and growing times may be improved, and product shelf life may be optimised.

It will be appreciated that a farming system, method and devices can be designed for a particular application using various combinations of devices and arrangements described above. It will be appreciated that the features described above may all be used together in a single system. In other embodiments of the invention, some of the features may be omitted. The features may be used in any compatible arrangement. Many variations and modifications not explicitly described above are possible without departing from the scope of the invention as defined in the appended claims.

1-18. (canceled)

19. A grow tray comprising:
a perimeter wall; and
a base including an irrigation opening extending through the base for allowing fluid to enter and leave the grow tray, wherein the base is configured to be couplable to a conduit to allow fluid communication between the conduit and the base via the irrigation opening.

20. The grow tray of claim 19, wherein the irrigation opening is disposed at a centre of the base.

21. The grow tray of claim 19, wherein the base comprises:
one or more primary channels extending between the irrigation opening and the perimeter wall, the one or main channels dividing the base into a plurality of contiguous sections; and
wherein each section includes a plurality of secondary channels, each secondary channel being connected to at least one of the primary channels to allow fluid communication between the irrigation opening and the secondary channels via the one or more primary channels.

22. The grow tray of claim 21, wherein the base comprises:
a plurality of primary channels extending radially from the irrigation opening towards the perimeter wall, and the plurality of secondary channels extend circumferentially about the irrigation opening between adjacent primary channels.

23. The grow tray of claim 22, wherein the plurality of secondary channels are configured and arranged to form a plurality of concentric rings centred on the irrigation opening.

24. The grow tray of claim 22, wherein the base further comprises:
a plurality of tertiary channels extending radially between adjacent secondary channels configured and arranged to allow fluid communication between the secondary channels via the tertiary channels.

25. The grow tray of claim 21, wherein the base comprises:
an inner portion including the primary and secondary channels, and a perimeter portion surrounding the inner portion, the perimeter portion including a plurality of secondary perimeter channels extending perpendicularly from the perimeter wall to the inner portion to allow fluid communication between the inner portion and the perimeter wall.

26. The grow tray of claim 21, wherein the primary channels are deeper than the secondary channels.

27. The grow tray of claim 21, wherein the primary and secondary channels are defined by grooves in the base.

28. The grow tray of claim 21, wherein the base comprises:
a substantially horizontal top surface for supporting a sheet of growing substrate in a substantially horizontal orientation.

29. The grow tray of claim 28, wherein the base comprises:
a plurality of radially extending fins located in the irrigation opening that partially define the substantially horizontal top surface.

30. The grow tray of claim 19, wherein the bottom of the base comprises:
a toroidal protrusion or toroidal recess encircling the irrigation opening for cooperating with a complementary toroidal recess or toroidal protrusion respectively on a conduit to be coupled to the bottom of the base.

31. The grow tray of claim 30, wherein the bottom of the base comprises:
a groove encircling the toroidal protrusion or toroidal recess for receiving an end of the conduit.

32. The grow tray of claim 19, wherein:
the base comprises:
a first pair of parallel perimeter edges; and
the grow tray comprises:
a first pair of diametrically opposed locating features extending parallel to the first pair of parallel perimeter edges for cooperating with a complementary pair of locating features on a support structure; and
midpoints of the locating features of the first pair of locating features are aligned along a first axis running through a centre of the irrigation opening and perpendicularly through the first pair of parallel perimeter edges.

33. The grow tray of claim 32, wherein:
the base comprises:
a second pair of parallel perimeter edges; and
the grow tray comprises:
a second pair of locating features extending parallel to the second pair of parallel perimeter edges for cooperating with a complementary pair of locating features on a support structure; and
the midpoints of the locating features of the second pair of locating features are aligned along a second axis running through the centre of the irrigation opening and perpendicularly through the second pair of parallel perimeter edges.

34. The grow tray of claim 32, wherein the first and/or second pair of locating features are protrusions or recesses.

35. The grow tray of claim 19, comprising:
one or more stacking protrusions disposed on one of: (i) a bottom side of the base; and (ii) a top of the perimeter wall; and
one or more complementary stacking recesses disposed on the other of: (i) a bottom side of the base; and (ii) the top of the perimeter wall;
wherein a maximum height of the one or more stacking protrusions is larger than a maximum height of the one or more stacking recesses to form a vertical gap between adjacent grow trays when vertically stacked.

36. The grow tray of claim 35, wherein the protrusions and recesses have a trapezoidal shape.
